(19) United States
(12) Patent Application Publication
(10) Pub. No.: US 2019/0016331 A1
(43) Pub. Date: Jan. 17, 2019

(54) PROGRAMMING COMPLEX PARKING MANEUVERS FOR DRIVERLESS VEHICLES

(71) Applicant: NIO USA, INC., San Jose, CA (US)

(72) Inventors: Jamie P. Carlson, San Jose, CA (US); Yadunandana Yellambalase, San Jose, CA (US)

(73) Assignee: NIO USA, INC., San Jose, CA (US)

(21) Appl. No.: 15/650,763

(22) Filed: Jul. 14, 2017

(51) Int. Cl. B60W 30/06; G05D 1/00; G06K 9/00

(52) U.S. Cl. CPC B60W 30/06; G05D 2201/0213; G06K 9/00812; G05D 1/0088

(57) ABSTRACT

Various embodiments relate generally to autonomous vehicles and associated mechanical, electrical and electronic hardware, computing software, including autonomy applications, image processing applications, etc., computing systems, and wired and wireless network communications to facilitate autonomous control of vehicles, and, more specifically, to systems, devices, and methods configured to control driverless vehicles to facilitate complex parking maneuvers with, for example, optional modification of a preprogrammed path of travel responsive to characteristics of an autonomous vehicle. In some examples, a method may be configured to localize an autonomous vehicle relative to a first geographical location, capture vehicular drive parameter data as the autonomous vehicle transits via a path of travel, localize the autonomous vehicle relative to a second geographical location, store data representing the vehicular drive parameters, and compute a reverse path of travel over the path of travel based on data representing one or more vehicular drive parameters.

### FIELD

Various embodiments relate generally to autonomous vehicles and associated mechanical, electrical and electronic hardware, computing software, including autonomy applications, image processing applications, etc., computing systems, and wired and wireless network communications to facilitate autonomous control of vehicles, and, more specifically, to systems, devices, and methods configured to control driverless vehicles to facilitate complex parking maneuvers with, for example, optional modification of a preprogrammed path of travel responsive to a characteristics of an autonomous vehicle.

### BACKGROUND

To assist in driving and refueling automobiles, a few approaches have been developed to assist drivers in automating conventional vehicles (e.g., manually-driven automotive vehicles) to aid in performing relatively simple tasks and maneuvers. For example, some conventional automobiles have been designed to assist a human driver, whether manually or automatically, to perform parallel parking. While humans may perceive parallel parking as difficult, it is a relatively simple process that depends predominantly on the size of the space in which the automobile is to be parked. While functional, conventional self-parking mechanisms suffer a number of drawbacks. As one example, known self-parking mechanisms are generally limited to simple actions and are not well-suited to implement complex or any other intricate parking or driving action.

In the development of clean energy technologies and vehicles, automobiles have been developed to use alternative fuels other than petroleum-based fuel. For example, some electric vehicles have been developed to consume electricity as an “alternative fuel,” as defined, for example, the Energy Policy Act of 1992. Other vehicles have been developed to consume other types of alternative fuels, such as hydrogen. However, adoption of alternative fuel vehicles has lagged due to, at least in part, to relatively slow pace of constructing alternative fueling mechanisms and stations. The slowed rate of building alternative fuel stations may be due to the relatively high cost of resources (e.g., physical stations) to build such stations. Further, some charging stations may service electric vehicles that require multiple hours to fully recharge a battery. Thus, a scarcity in the availability to use alternative fuel stations might be expected, along with increased queues and difficulties in coordinating refueling with impromptu travel plans. In some cases, some conventional electric charging stations are networked to provide indications whether a station is in used. However, the logic used in the conventional electric charging stations is suboptimal to ensure an alternate fuel vehicle may refueled (e.g., recharged) in a timely and cost-effective manner without disrupting users' experiences. Other drawbacks are also present in a variety of known approaches to refueling of traditional alternate fuel vehicles.

Thus, what is needed is a solution for implementing autonomous control functions to facilitate parking and replenishment autonomous vehicles, without the limitations of conventional techniques.

### BRIEF DESCRIPTION OF THE DRAWINGS

Various embodiments or examples (“examples”) of the invention are disclosed in the following detailed description and the accompanying drawings:

FIG. 1 is a diagram depicting an example of an independent parking controller, according to some embodiments;

FIG. 2 is a diagram depicting another example of an independent parking controller, according to some embodiments;

FIG. 3 is a flow diagram depicting an example of capturing vehicular drive parameters to form data representing a path of travel, according to some embodiments;

FIG. 4 is a flow diagram depicting an example of adapting usage of vehicular drive parameters between those based on generated trajectories and those based on a preprogrammed path of travel, according to some embodiments;

FIGS. 5A to 5B are diagrams depicting examples of autonomy controllers configured to implement driverless customized parking using a subset of vehicular drive parameters, according to some embodiments;

FIG. 6 is a diagram depicting an example of an autonomy controller configured to modify a path of travel to implement driverless customized parking, according to some embodiments;

FIG. 7 is a diagram depicting another example of an autonomy controller configured to modify a path of travel to implement driverless customized parking, according to some embodiments;

FIG. 8 is a diagram depicting an example of an autonomy controller configured to implement a preprogram path of travel to implement a driverless approach to a fuel replenishment station, according to some embodiments;

FIG. 9 is a diagram depicting an example of an autonomy controller configured to coordinate driverless transit to a fuel replenishment station, according to some embodiments;

FIG. 10 is a diagram depicting an example of a coordination computing platform configured to coordinate driverless transit to a fuel replenishment station, according to some embodiments;

FIG. 11 is a flow diagram depicting an example of determining whether to coordinate driverless transit to a fuel replenishment station, according to some embodiments;

FIG. 12 is a flow diagram depicting an example of coordinating driverless transit to a fuel replenishment station, according to some embodiments; and

FIG. 13 illustrates examples of various computing platforms configured to provide various functionalities to components of an autonomy controller, according to various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims, and numerous alternatives, modifications, and equivalents thereof. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

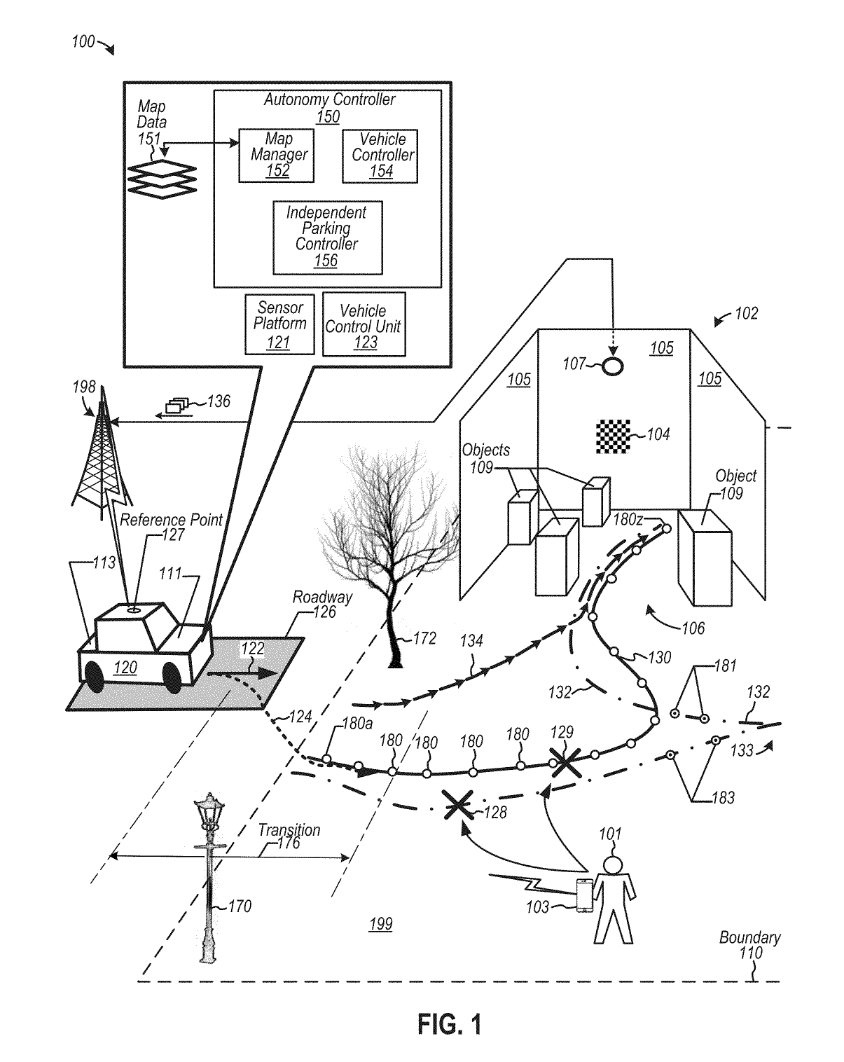

FIG. 1 is a diagram depicting an example of an independent parking controller, according to some embodiments. Diagram 100 depicts an example of an independent parking controller 156 configured to determine a boundary 110 surrounding a destination geographic location 102, and configured further to navigate autonomously an autonomous vehicle 120 within boundary 110 via a path of travel 130 to a parking location 106 (e.g., point of termination) at which autonomous vehicle 120 may be positioned driverlessly in a customized orientation and position (e.g., without real-time input from a human operator). In the example shown, destination geographic location 102 may be a carport (e.g., a parking port) or a garage 102 including structural walls 105 and distributed objects 109, which may be any item typically stored in a garage, such as a tool bench, a bicycle, a motorcycle, a storage rack, a lawn mower, a treadmill or other exercise equipment, lawn furniture, etc. Objects 109 may be arranged arbitrarily by preference or to optimize space within garage 102. Thus, an autonomy controller 150 in autonomous vehicle 120 may be configured to implement customized automated parking maneuvers to adapt orientation of vehicle 120 during self-parking processes relative to objects 109, while optionally preserving space adjacent a passenger, if any, to enter and exit autonomous vehicle 120 when parked in a customized position and orientation. As an example, if an object 109 is a work bench, autonomous vehicle 120 may be programmed to park in a customize orientation and position relative to the work bench so as to optimize space (e.g., floor space) in garage 102, according to the preferences of user 101.

Independent parking controller 156 may “learn” characteristics, such as vehicular drive parameters, associated with traversing a path of travel 130, whereby independent parking controller 156 may reuse the learned characteristics to automatically guide the transit of autonomous vehicle 120 via the same (or substantially the same) path of travel 130 to park at a customized position and orientation. Independent parking controller 156 may be configured to detect and store vehicular drive parameters (or values thereof) as autonomous vehicle 120 transits over via a path segment 130. Examples of vehicular drive parameters include parameter data representing steering data (e.g., degree(s) of wheel angle to effect a turn), acceleration data (e.g., an amount of throttle or power to apply to a drive train or the like), deceleration data (e.g., an amount of pressure to apply to brakes to reduce velocity), transmission data (e.g., a state of a transmission subsystem to effect forward motion and reverse motion in one or more states of speed and torque), and the like.

Thus, the vehicular drive parameters may include subsets of data that describe certain behaviors or states of various subsystems of autonomous vehicle 120. Examples of subsystems include a steering subsystem, a braking subsystem, a propulsion subsystem, a transmission subsystem, and the like. With various vehicular drive parameters stored relative to each of different units of travel, independent parking controller 156 may be configured to cause autonomous vehicle 120 to traverse path of travel 130 repeatedly. For example, independent parking controller 156 may store subsets of vehicular drive parameters at initial waypoint 180a, with subsequent values of vehicular drive parameters being captured at subsequent units of travel, or waypoints 180, through to terminus waypoint 180z. So, as autonomous vehicle 120 crosses into area 199 of boundary 110, independent parking controller 156 may generate principal path routing data that sequences changes in vehicular drive parameters as autonomous vehicle 120 transits over path of travel 130 from waypoint 180 to waypoint 180. For example, values of steering or wheel angles at sequential waypoints 180 may be used to automatically steer autonomous vehicle 120 along a common path. Autonomous vehicle 120 then may cease transit at terminus waypoint 180z in an orientation and position as desired by a user who programs or generates path of travel 130 for automated and repeatable use. In some examples, a waypoint may be in intermediate point or unit of travel that may be unique relative to a point in time, a geographic location, etc., whereby a waypoint may be associated with a subset of vehicular drive parameters recorded at, or to be used at, the waypoint.

Independent parking controller 156 may be configured to initiate vehicular drive parameter recordation in response to user input, according to some examples. For example, independent parking controller 156 may receive a user input configured to initiate recordation of vehicular drive parameter(s). The user input may be entered into the user interface on a mobile computing device 103 (e.g., a mobile phone), on an interface in autonomous vehicle 120, or any other user interface. In response, independent parking controller 156 may be configured to detect values representative of the vehicular drive parameters and store the detected vehicular drive parameters to form preprogrammed vehicular drive parameters, which constitute a preprogrammed path segment over which autonomous vehicle 120 may be guided. According to some examples, independent parking controller 156 may be configured to generate a macro program or application, based on the stored vehicular drive parameters, to enable multiple implementations of the preprogrammed path segment each time the macro is activated. In some cases, a macro programming language, such as a script programming language, may record actions of vehicle subsystems (e.g., responsive to human driver input) that can be repeated sequentially upon execution of the macro. According to alternate examples, independent parking controller 156 may be configured to automatically record vehicular drive parameters after which the vehicular drive parameters may be retrieved from a memory and implemented to form a preprogrammed path of travel 130. For example, as autonomous vehicle 120 traverses path of travel 130 for a first time (e.g., under human driver control), driver parameters may be recorded. Anytime thereafter, autonomous vehicle 120 may automatically implement the preprogrammed path of travel 130 for driverless parking in garage 102.

According to various examples, independent parking controller 156 may be configured to capture various subsets of vehicular drive parameters at a set of waypoints to preprogram any number of paths of travel between, for example waypoint 180a and waypoint 180z. In the example shown, vehicular drive parameters for path of travel 130 may be captured as autonomous vehicle 120 traverses from waypoint 180a to 180z. Or, the vehicular drive parameters for path of travel 130 may be captured as autonomous vehicle 120 traverses from waypoint 180z to 180a. In some examples, independent parking controller 156 may be configured to implement waypoints captured sequentially from waypoint 180a to waypoint 180z in a reverse manner. In particular, autonomous vehicle 120 may be driving autonomously along path 122 such that at waypoint 180a, drive parameter data is captured at subsequent waypoints 180 until autonomous vehicle 120 enters garage 102 and terminates travel at waypoint 180z. Hence, anterior portion 111 of autonomous vehicle 120 may be a leading portion that enters garage 102 first. Thereafter, autonomous vehicle 120 may be configured to exit garage 102 with the posterior portion 113 leading along path of travel 130 by using drive parameter data in a reverse manner from waypoint 180z to waypoint 180a (e.g., autonomous vehicle drives in reverse). So, at least in some examples, a human driver may provide input to establish values of vehicular drive parameters during an initial traversal of path of travel 130, with the stored vehicular drive parameters being used repeatedly and driverlessly thereafter regardless of whether autonomous vehicle 120 is entering or exiting garage 102.

Further, independent parking controller 156 may be configured to capture a subset of vehicular drive parameters via a path of travel 132 over which an autonomous vehicle 120 may transition a transmission state from a reverse state (e.g., a reverse gear) to a forward state (e.g., a forward gear), or vice versa, at a portion 133 of path of travel 132. Thus, autonomous vehicle 120 may implement path of travel 130 to exit with anterior portion 111 of autonomous vehicle 120 leading (e.g., driving in a forward gear), and may implement path of travel 132 to enter garage 102 with posterior portion 113 of autonomous vehicle 120 leading (e.g., driving in a reverse gear). Furthermore, waypoints 181 of path of travel 132 may be associated with transmission data representing a first direction (e.g., reverse), whereas waypoints 183 be associated with a second direction (e.g., forward).

Autonomous vehicle 120 is shown to include a sensor platform 121, a vehicle control unit 123, and an autonomy controller 150, one or more of which may include logic configured to detect a vehicular drive parameter to form a programmed path of travel, navigate autonomous vehicle 120 over a programmed path of travel, and determine whether to activate routing based on a programmed path of travel. Sensor platform 121 may include any number of sensors (not shown) with which to facilitate driverless control of autonomous vehicle 120. Examples of sensors include one or more image capture devices (e.g., image sensors or cameras to capture video including high definition, or “HD,” cameras), one or more radar devices (e.g., short-range radar, long-range radar, etc.), one or more LIDAR devices, one or more sonar devices (or sensors configured to detect ultrasound), one or more global positioning system (“GPS”) devices, one or more inertial measurement units (“IMU”) devices, and one or more other types of sensors including, but not limited to, gyroscopes, accelerometers, odometry sensors, steering wheel angle sensors, wheel angle sensors, throttle sensors, brake pressure sensors, proximity sensors (e.g., in or adjacent to a seat to determine whether occupied by a passenger), etc. An example of an image capture device may include high definition (“HD”) cameras (or CMOS/CCD sensors) that may have image resolutions greater than 640×480, such as 1280×720, 1920×1080, 2560×1600, or greater. Further, one or more cameras may operate to capture imagery at any range or spectral band of light. For example, a camera may be configured to capture images in the visible light or infrared light spectra. At least a subset of the aforementioned sensors of sensor platform 121 may be used to localize autonomous vehicle 120 relative to its environment and objects within the environment (e.g., relative to a lamp post 170, a tree 173, and the like), and relative to a position in a global coordinate system (e.g., using GPS coordinates). Further, one or more sensors of sensor platform 121 may sense specific states of wheel angles and throttle positions, as well as any other vehicular drive parameter to establish a preprogrammed path of travel.

Vehicle control unit 123 may be coupled (e.g., mechanically and/or electrically) to steering, braking, transmission, and propulsion units, or to any other component, with which to implement physical changes in steering, acceleration (e.g., throttling), deceleration (e.g., braking), transmission shifting (e.g., directional gear shifting). As an example, vehicle control unit 123 may include electronic interfaces with autonomy controller 150, and thus may be configured to receive data representing steering data (e.g., degree of wheel angle to effect a turn), acceleration data (e.g., an amount of throttle or power to apply to a drive train or the like), deceleration data (e.g., an amount of pressure to apply to brakes to reduce velocity), transmission data (e.g., representing a selected gear and/or a direction), and the like. Vehicle control unit 123 may be further configured to apply control signals to electromechanical systems of autonomous vehicle 120, responsive to the above-described data. In some examples, vehicle control unit 123 may apply changes to at least steering, acceleration and deceleration at a rate of thirty (30) times a second or greater. In some examples, vehicle control unit 123 may receive updates of above-described data at each waypoint 180 to facilitate course corrections or modifications, if any, to ensure autonomous vehicle 120 traverses over path of travel 130.

Diagram 100 depicts autonomy controller 150 including a map manager 152, a vehicle controller 154, and an independent parking controller 156. Autonomy controller 150 may include logic configured to generate and implement one or more preprogrammed paths of travel 130, 132, and 134, which are examples. The logic in autonomy controller 150 may include either hardware or software, or a combination thereof, and may be configured to perform any number of localization and self-parking processes to situate autonomous vehicle 120 in a customized position and orientation at a destination parking spot 106 relative to any number of moveable or affixed objects 109.

Vehicle controller 154 may include logic configured to control any number of vehicle functions under either human or autonomous control. For example, vehicle controller 154 may determine a pose (e.g., a position and/or orientation) localized at a reference point 127 of autonomous vehicle 120. Reference point 127 may be identified relative to external objects and surfaces of an external environment (or scene), and may be correlated to a position on a roadway 126, which may be described in map data 151. Reference point 127 may be expressed in longitudinal and latitudinal coordinates for identifying a geographic location. Further, vehicle controller 154 may be configured to determine a position of reference point 127 relative to monuments or markers that may be used as known locations or points in a coordinate system to confirm or facilitate localization of autonomous vehicle 120 relative to, for example, boundary 110. Examples of monuments or markers include lamp post 170, tree 172, any of objects 109, walls 105, an image target 104, and the like. Also, image target 104 may be implemented as a marker to localize autonomous vehicle 120 at parking space 106, and to guide computations to ensure orientation and position at which autonomous vehicle 120 comes to rest. In operation, vehicle controller 154 may be configured to facilitate localization of reference point 127 (i.e., autonomous vehicle 120) relative to boundary 110 and waypoint 180a of a path of travel 130, which may be preprogrammed path of travel. According to some examples, boundary 110 may approximate a transition 176 of controlling the routing of autonomous vehicle 120 between using a preprogrammed path of travel 130 in area 199 and using computer-generated trajectories 122 for path and route planning via any road network external to boundary 110, including roadway 126.

Further, vehicle controller 154 may be configured to implement object characterization and classification to identify types and attributes of objects (e.g., whether an object is dynamic or static, whether an object is animate, or living, rather than an inanimate object, etc.), according to some embodiments. Examples of external classified objects include lamp posts, trees, tool benches, bicycles, cars, signs, pedestrians, cyclists, dogs, fire hydrants, etc., and examples of classified external surfaces include pavement of roadway 126, surfaces or contours of adjacent buildings, such as carport or garage 102, or adjacent structures, such as a communication tower 198, and the like.

Vehicle controller 154 also may be configured to generate trajectories or paths of travel 122 in accordance with a planned route to guide the transiting of autonomous vehicle 120 via roadway 126 from origination point “A” (not shown) to destination point “B,” such as destination parking spot 106. For a trajectory or path of travel 122, vehicle controller 154 may determine in real-time (or substantially in real-time) a number of path segments constituting a path of travel along roadway 126. To transit along a segment, vehicle controller 154 may compute a number of vehicular drive parameters that may be applied incrementally to mechanical drive components (e.g., at a rate of 30 sets of vehicular drive parameters for every second) to cause autonomous vehicle 120 to automatically drive along trajectory-based path segments over roadway 126. Hence, vehicle controller 154 may be configured to compute one or more drive parameters in real-time (or substantially in real-time) with which to apply to vehicle control unit 123, including driving control signals to effect propulsion, steering, braking, transmission shifting, lighting (e.g., emergency flashers), sound (e.g., automatic horn alerts, etc.), among other functions.

Map manager 152 may be configured to implement map data 151 to localize and navigate autonomous vehicle 120 relative to roadway 126 or a driveway (not shown) in area 199 leading to parking space 106, any of which may be represented as image data. Map data 151 may include relatively high resolutions of images of roadway 126 and adjacent objects, such as communication tower 198, lamp post 170, tree 172, or walls 105. In some examples, map data 151 may include static or semi-static objects that have a relatively low or negligible probability of moving positions. Thus, static objects may be used as monuments or markers in accordance with some implementations. Autonomy controller 150 may use map data 151 to identify external imagery to facilitate route planning (e.g., planning paths of travel relative to roadway 126 as depicted in map data 151). Map data 151 may include image data representing lane markings as well as data representing lane widths and curbs (e.g., with curb markings, such as “loading zone,” etc.). In some examples, map data 151 may include image data having image resolutions greater than 640×480, such as high definition resolutions of 1280×720, 1920×1080, 2560×1600, or greater. Further, one or more cameras may operate to capture imagery at any range of wavelengths or any spectral bands of light, regardless of an HD resolution. For example, a camera may be configured to capture images in the visible light or infrared light spectra. Thus, map data 151 may include images depicted in the visible light spectra, the infrared light spectra, or the like. Map data 151 may also include any type of map data, such as 2D map data, 3D map data, 4D map data (e.g., includes three dimensional map data at a particular point in time), or the like. Additionally, map data 151 may include route data, such as road network data, including, but not limited to, route network definition file (“RNDF”) data (or similar data) and the like.

Map manager 152 may also be configured to generate a dynamic representation of map data 151 by fusing or combining static map data (e.g., image data representing visual characteristics of roadway 126 and static objects, such as lamp post 170, tree 172, etc.) and dynamic map data to form dynamic map data 151. In some examples, dynamic map data may include data representing objects detected via image capture (and/or other sensor data, including lidar), whereby the objects may have attributes indicative of dynamism, such as a pedestrian or a cyclist. In at least one case, dynamic map data may include temporally-static objects (e.g., semi-static objects), which may be temporally static for a certain duration of time (e.g., during construction or times of day) and may be added or removed dynamically from a mapped environment. For example, another vehicle (not shown) may generally be parked in area 199 during hours that another driver (e.g., a family member) is not using the vehicle. Examples of temporally-static objects include a parked car in a driveway, both of which may be omitted initially from map data 151. However, a parked car may be included in a dynamic representation of map data 151 as an object in a map as the object is captured.

In some examples, map data 151 may include images in high resolutions that include granular details of an environment or scene in which an autonomous vehicle is driving to ensure relatively accurate and precise localization, object classification, navigation, path of travel generation (e.g., trajectory generation), etc., as well as ensuring accurate and precise customized orientation and positioning when parking a vehicle driverlessly. According to some implementations, portions of map data 151 associated with a planned route along various paths of travel may be downloaded (e.g., as adjacent blocks of grid-type HD map data) as an autonomous vehicle travels along the route, thereby preserving resources (e.g., relatively large amount of storage need not be required to store an entire HD map of a particular region, such as a country).

According to some examples, map manager 152 may receive map update data 136 via communication tower 198 and a network with which to apply to map data 151 for updating, for example, features or objects as imagery relative to parking spot 106, interior of garage 102, and/or surface area 199. As an example, an object other than autonomous vehicle 120, such as a car, may be disposed along path of travel 130 or in parking space 106. Data 136 include information about the object (e.g., a type of object, size of object, position of object, etc.) that may be transmitted to update map data 151 so that independent parking controller 156 can determine an alternate path of travel, such as path of travel 134, if a parked car obstructs path of travel 130. Thus, independent parking controller 156 may be configured to select one preprogrammed path of travel from a set of preprograms paths of travel to implement driverless parking prior to the arrival at boundary 110 or garage 102. In some cases, map update data 136 may originate from one or more sensor devices 107 having similar image capturing or ranging capabilities (e.g., lidar, radar, and/or HD cameras as sensors in autonomous vehicle 120). Note, too, that updated map data 136 may be transmitted to any number of autonomous vehicles 120 authorized to park at parking spot 106 to revise on-board maps. Therefore, autonomy controller 150 may use updated on-board map data 151 to more accurately and precisely navigate within boundary 110 along a preprogrammed path of travel.

According to some examples, autonomy controller 150 may be configured to generate and store data representing a path of travel as, for example, a preprogrammed path of travel that facilitates customized parking adapted to a user's preference in positioning and orienting autonomous vehicle 120 at a parking spot 106. Independent parking controller 156 may begin forming a preprogrammed path of travel by localizing autonomous vehicle 120 relative to a first geographical location at a first path portion. For example, vehicle controller 154 may localize autonomous vehicle 120 and generate location data (e.g., in terms of latitude and longitude, GPS coordinates, etc.). Independent parking controller 156 may use location data to identify a location of a waypoint at which vehicular drive parameters can be captured. In one instance, a first path portion may be associated with boundary 110 and the first geographic location may be waypoint 180a. Hence, path of travel 130 originates adjacent to boundary 110. Or, if path of travel 130 originates within garage 102, the first path portion may be associated with parking spot 106 and the first geographic location may be waypoint 180z. Independent parking controller 156 may be configured to capture data representing vehicular drive parameters at waypoints 180. In some examples, each waypoint 180 of path of travel may include data representing a “unit of travel,” whereby a unit of travel may describe one or more units of time, one or more units of distance, and the like. For example, waypoints 180 may be geographically displaced from each other in units of distance (e.g., a number of inches or feet from each other along a path of travel), or may be separated in time (e.g., units of seconds or fractions thereof from each other).

Independent parking controller 156 may continue forming a preprogrammed path of travel by localizing autonomous vehicle 120 relative to a second geographical location at a second path portion. In one example, the second path portion may be associated with parking spot 106 and the second geographic location may be waypoint 180z. Or, the second path portion may be associated with boundary 110 and the second geographic location may be waypoint 180a. Further, independent parking controller 156 may be configured to store captured data representing vehicular drive parameters for each of waypoints 180. In various examples, independent parking controller 156 may generate a macro application based on captured waypoints and vehicular drive parameters. The macro, when executed, can cause autonomous vehicle 122 to driverlessly traverse waypoints, such as from waypoint 180a to waypoint 180z, with accuracy and precision provided by predetermined vehicular drive parameters that may initially be specified by a user. In particular, a macro can facilitate an automated approach of autonomous vehicle 120 into garage 102 so that it arrives and parks driverlessly at parking spot 106 in an accurate and precise pose (e.g., orientation and position) in accordance with a user's preferences relative to surrounding objects 109.

Additionally, independent parking controller 156 may be configured to form a modified macro application to generate executable instructions to facilitate transit over the path of travel 130 in a reverse manner than was initially captured. For example, if a macro application is based on a preprogrammed path of travel originating at waypoint 180a and terminating at waypoint 180z, then independent parking controller 156 may be configured to generate executable instructions to facilitate driverless transit originating at waypoint 180z and passing through waypoint 180a as autonomous vehicle 120 exits boundary 110. Thus, independent parking controller 156 may apply predetermined vehicular drive parameters in a reverse sequence to enable autonomous vehicle to travel in a reverse direction travel over path of travel 130. Note that the reverse direction of travel may be either in a forward gear or a reverse gear relative to a transmission.

According to various additional examples, autonomy controller 150 may also be configured to transition path planning between trajectory-generated paths, which may be configured for implementation external to boundary 110, and preprogrammed paths of travel configured for implementation within boundary 110. External to boundary 110, vehicle controller 154 may be configured to calculate a variety of trajectories per unit time (e.g., per second), in real-time or substantially in real-time, that may be used to guide autonomous vehicle along a route from a point of origination to a point of destination, most of which may be calculated to facilitate driverless control external to boundary 110. For example, vehicle controller 154 may select and implement a trajectory relative to locations of external dynamic and static objects along a sequence of roadways that provides for collision-free travel over the roadways, such as roadway 126. Thus, autonomy controller 150 may also be configured to compute vehicular drive parameters based on the calculated trajectories to facilitate transit of autonomous vehicle 120 to a destination geographical location, such as within boundary (e.g., at parking spot 106).

Further, Independent parking controller 156 may be configured to adapt the usage of vehicular drive parameters from those based on trajectories external to boundary 110 to those based on waypoints 180 within boundary 110. For example, independent parking controller 156 may be configured to identify a trajectory 122 (and associated vehicular drive parameters) that is to be adapted to, for example, a path of travel 130 at waypoint 180a. Independent parking controller 156 includes logic to predict a change in a path of travel during transition 176 during which autonomy controller 150 adaptively switches via a transitory path portion 124 from using trajectory-based drive parameters to preprogrammed drive parameters. Therefore, independent parking controller 156 may be configured to access map data 151 to identify boundary 110 to detect that autonomous vehicle 120 is on approach to boundary 110. During transition 176, independent parking controller 156 may be configured to access executable instructions, such as a macro application, to facilitate vectoring autonomous vehicle 120 in accordance with an approach maneuver, such as one of a number of preprogrammed paths of travel 130, 132, 134, among others. In at least one example, as autonomous vehicle 120 approaches boundary 110, independent parking controller 156 may be configured to select one or a number of preprogrammed paths of travel to implement, according to one or more criteria including whether user 101 provides input.

According to some embodiments, user 101 (or any other passenger) may enter or exit autonomous vehicle 120 within boundary 110, and may generate or modify a path of travel via an application implemented on a mobile computing device 103. User 101 may apply (e.g., via mobile computing device 103) a subset of alternate vehicular drive parameters to guide the autonomous vehicle to a termination point at parking spot 106. For example, user 101 may exit autonomous vehicle 120 at point 129 along path of travel 130 or at point 128 along path of travel 132. Autonomy controller 150 then may detect an absence or presence of a driver or passenger via proximity sensors in or adjacent to a seat in autonomous vehicle 120. As one or more passengers may exit autonomous vehicle 120 at points 128 and 129 prior to parking, independent parking controller 156 may be configured to adjust the orientation and position of autonomous vehicle 120 as it parks in parking spot 106. Modification of the orientation and position may enhance spatial disposition of autonomous vehicle 120 within garage 102. For instance, if driver 101 exits autonomous vehicle 120 as its only passenger, then independent parking controller 156 may be configured to adjust the orientation and position of autonomous vehicle 120 to disregard a requirement for space to accommodate an open door. As such, the autonomous vehicle 120 may be parked relatively close to one or more surfaces of objects 109 to, for example, optimize space surrounding at least a portion of autonomous vehicle 120. Note that a “driverless” autonomous vehicle may refer to, at least in one example, to a vehicle that may be configured to be either manually-driven (e.g., human operator provides control signal input) or automated (e.g., a computing system, such as an autonomy controller controls propulsion and steering).

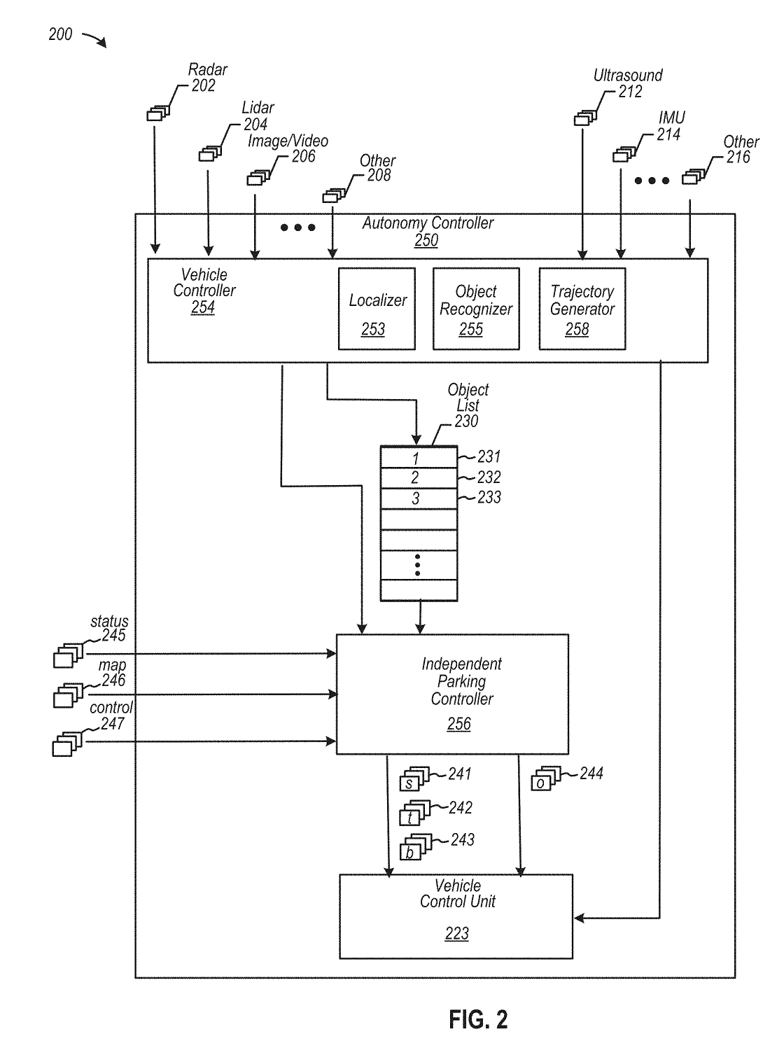

FIG. 2 is a diagram depicting another example of an independent parking controller, according to some embodiments. Diagram 200 depicts autonomy controller 250 including a vehicle controller 254 configured to generate an object list 230, among other things. Autonomy controller 250 also includes an independent parking controller 256 and a vehicle control unit 223. As shown, autonomy controller 250 may be configured to receive radar sensor data 202, lidar sensor data 204, image/video data 206, and other sensor data 208, each of which may be received into vehicle controller 254. Also, autonomy controller 250 also may be configured to receive ultrasound sensor data 212, inertial measurement unit (“IMU”) data 214, and other sensor data 216 (e.g., GPS data, wheel or odometry data, gyroscopic data, etc.), each of which may be received into vehicle controller 254 or any component of autonomy controller 250.

Vehicle controller 254 may, in some examples, be configured to facilitate localization or any other function performed by components of an autonomous vehicle. For example, localizer 253 can determine a pose (e.g., a local position and orientation) at any one of number of geographic locations. As such, localizer 253 may use acquired sensor data, such as sensor data associated with lamp posts, trees, or surfaces of buildings (e.g., a garage), which can be compared against reference data, such as map data (e.g., 3D map data, including reflectance data) to determine a local pose. According to some examples, localizer 253 may determine a relative geographic location of an autonomous vehicle relative to, for example, a global coordinate system (e.g., latitude and longitudinal coordinates, etc.).

Vehicle controller 254 may be configured to facilitate object identification. For example, object recognizer 255 may be configured to implement object characterization and classification to identify types and attributes of objects (e.g., whether an object is dynamic or static, such as whether an object is animate or inanimate), according to some examples. Examples of classified objects include lamp posts, trees, tool benches, bicycles, cars, signs, pedestrians, cyclists, dogs, fire hydrants, etc., and examples of classified external surfaces include pavement of a roadway, surfaces or contours of adjacent buildings, such as garage 102 of FIG. 1, or adjacent structures, such as a communication tower 198 of FIG. 1, and the like. In the example shown, vehicle controller 254 may detect and classify objects to generate an object list 230, which includes a list of objects, such as object (“1”) 231, object (“2”) 232, object (“3”) 233, etc. The objects may represent detect and/or classified objects detected by one or more sensors. For example, objects 231, 232, and 233 may include static objects, such as a lamp post, and dynamic objects, such as a person walking.

Also, trajectory generator 258 may be configured to generate trajectories or paths of travel in accordance with a planned route to guide the transiting of an autonomous vehicle via a roadway from origination point “A” (not shown) to destination point “B,” such as a destination parking spot. To determine a trajectory-based path of travel, trajectory generator 258 may determine in real-time (or substantially in real-time) a number of path segments to evaluate a collision-free path of travel along a roadway. Trajectory generator 258 may implement object list 230 to select trajectories that may avoid collisions with objects 221, 232, and 233. To transit along a segment, trajectory generator 258 may compute a number of vehicular drive parameters that may be applied incrementally to mechanical drive components to cause an autonomous vehicle to traverse along path segments driverlessly over the roadway. Hence, trajectory generator 258 may be configured to compute one or more vehicular drive parameters in real-time (or substantially in real-time) with which to apply to independent parking controller 256 or vehicle control unit 123, including driving control signals to effect propulsion, steering, braking, transmission shifting, lighting (e.g., emergency flashers), sound (e.g., automatic horn alerts, etc.), among other functions.

In some examples, autonomy controller 250 may receive status data 245, map data 246, and control data 247. Status data 245 may include state data about one or more components or sub-systems of an autonomous vehicle (e.g., existence of high temperatures in an electrical power plant or in other electronics, a state of power degradation or voltage degradation, etc.). Responsive to state data of the one or more components or sub-systems, independent parking controller 156 may be configured to modify a path of travel associated with a parking spot to, for example, modify an orientation or position of the vehicle as it parks. Map data 246, which may be optionally applied, may include data representing supplemental map data to assist in customized self-parking. Control data 247, which may be optionally applied, may include data representing supplemental commands originating from, for example, a user interface, such as on a mobile computing device or in the autonomous vehicle (not shown). One or more elements depicted in diagram 200 of FIG. 2 may include structures and/or functions as similarly-named or similarly-numbered elements depicted in other drawings, or as otherwise described herein, in accordance with one or more examples.

According to some examples, independent parking controller 256 may be configured to perform path planning, such as selecting an optimal path of travel that is collision-free based on, for example, terminating transit in a specialized orientation and position. Independent parking controller 256 may also generate drive parameters as (or as part of) command data, such as steering data 241, throttle data 242, braking data 243, or any other data 244, such as transmission shifting data (e.g., data describing gear and either a forward or reverse direction), for execution by vehicle control unit 223, which, in turn, may generate low-level commands or control signals for application to actuators or other mechanical or electro-mechanical components to cause changes in steering angles, velocity, etc.

Any functionality of one or more components of autonomy controller 250 (e.g., vehicle controller 254, independent parking controller 256, and vehicle control unit 223) may be combined with any other component or may be distributed among any number of other components. In one example, either independent parking controller 256 or vehicle controller 254, or a combination thereof, may be configured to perform one or more functions of an advanced driver assistance system (“ADAS”) to control an autonomous vehicle. In some examples, autonomy controller 250 and any of its one or more components may be implemented in hardware or software (or a combination thereof). According to some examples, logic implemented in autonomy controller 250 may include executable instructions based on C++ programming languages, or any other programming language. Note, too, that data may be exchanged within or without an autonomous vehicle via vehicle-to-vehicle (“V2V”) data links or vehicle-to-infrastructure (“V2I”), among other communication media, protocols, and technologies.

In a specific example, one or more components of autonomy controller may be implemented as one or more processors, such as one or more graphics processing units (“GPUs”) configured to implement a framework and programming model suitable for GPUs. For example, a programming language, such as ‘Compute Unified Device Architecture’ (“CUDA”)-based language, or any other compatible programming language that may be used to program the GPUs. CUDA™ is produced and maintained by NVIDIA of Santa Clara, Calif. Note that other programming languages may be implemented, such as OpenCL, or any other parallel programming language

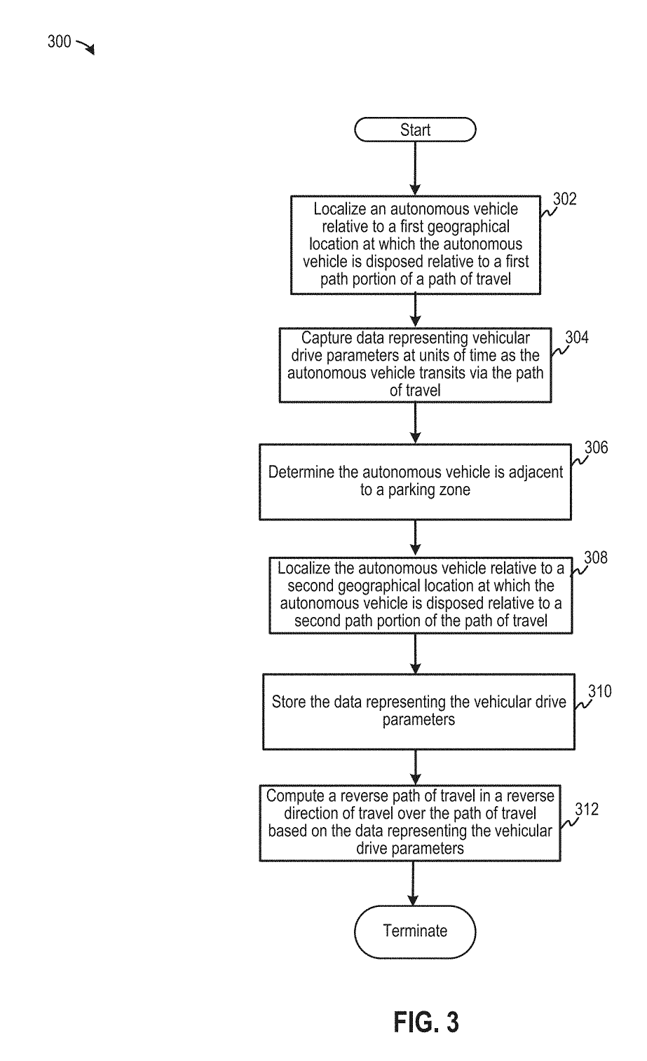

FIG. 3 is a flow diagram depicting an example of capturing vehicular drive parameters to form data representing a path of travel, according to some embodiments. Flow 300 begins at 302, at which an autonomous vehicle may be localized relative to a roadway over which the autonomous vehicle is transiting via a path of travel. The autonomous vehicle also may implement a high definition map data that may include one or monuments or markers with which to localize an autonomous vehicle at a geographic location relative to a path portion of a path of travel. The geographic location may be a waypoint adjacent a boundary or a waypoint at a customized parking location.

An autonomous vehicle, as described with respect to flow 300 or any other figure, may refer to any vehicle that has logic or an automated driving system configured to perform any level of automated driving, according to various embodiments. For example, an autonomous vehicle may refer to a level 4 automated vehicle (e.g., “high automation”), as well as an automated vehicle at level 3 (e.g., conditional automation) or at level 5 (e.g., full automation), whereby such levels are defined by SAE International (“SAE”) of Warrendale, Pa., USA, or as adopted by the National Highway Traffic Safety Administration of Washington, D.C., USA. An autonomous vehicle, as described herein, may be described as an “autonomous-capable vehicle,” which can be controlled by either a human or autonomous logic, or both, under any condition, at least in some examples.

At 304, data representing vehicular drive parameters may be captured at units of travel (e.g., at waypoints) as the autonomous vehicle transits via a path of travel. Here, data capture may be initiated to form a programmed path of travel (e.g., as a macro) responsive to accepting control signals from a subset of user control devices, examples of which include a steering mechanism, a throttle, a braking device, and a transmission shifting control, among others. In some examples, data capture may be initiated at a user interface (e.g., at a mobile phone or an interface within the autonomous vehicle).

At 306, and autonomous vehicle may be determined to be adjacent to a parking zone or location. In some examples, when an autonomous vehicle is adjacent to a targeted parking location, an independent parking controller may implement image data to capture imagery of an image target (e.g., a checkerboard, such as shown as 104 in FIG. 1, or any other symbolic or visual control image) for purposes of localization when orienting and positioning a vehicle driverlessly.

At 308, the autonomous vehicle may be localized at another geographic location relative to another path portion of a path of travel, whereby the other geographic location may be another waypoint at a terminated end of a programmed path of travel adjacent to either a boundary or at a customized parking location (e.g., depending on the direction of transit over the path of travel). At 310, data representing vehicular drive parameters for each of the waypoints may be stored for later implementation as part of a macro application. At 312, a reverse path of travel may be computed in a reverse direction, thereby using previously-captured vehicular drive parameters in a sequence in a reverse manner (e.g., opposite from the sequence in which waypoint data may be captured). Hence, data representing a preprogrammed path of travel in one direction may be used for driverless transit over the path of travel in either direction.

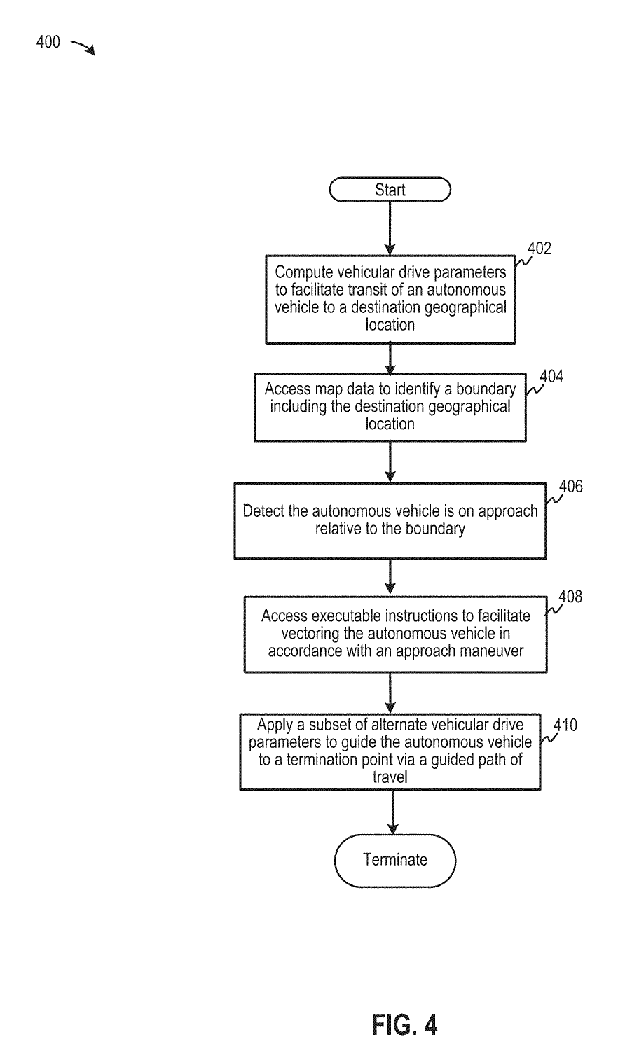

FIG. 4 is a flow diagram depicting an example of adapting usage of vehicular drive parameters between those based on generated trajectories and those based on a preprogrammed path of travel, according to some embodiments. Flow 400 begins at 402, at which subsets of vehicular drive parameters are computed to facilitate transit of an autonomous vehicle to a destination. In some examples, the subsets of vehicular drive parameters may be computed in real-time (or substantially in real-time) based on trajectories generated by a trajectory generator. At 404, map data may be accessed to identify a location of a boundary, such as geo-fence, to predict a transition from using generated trajectories for planning routes to using a preprogrammed path of travel to implemented customized parking driverlessly. At 406, an autonomous vehicle may be configured to detect its approach relative to a boundary within a range of distances. In at least one range of distances, an independent parking controller may be configured to adapt an initial path of travel to terminate at one or more initial waypoints of a preprogrammed path of travel, thereby effecting a relatively smooth or seamless transition from using instantaneously determined paths of travel to predetermined paths of travel.

At 408, executable instructions are access to facilitate vectoring of the autonomous vehicle in accordance with an approach maneuver implemented as a preprogrammed path of travel. For example, control logic in an autonomous vehicle may detect that it is approaching a boundary at 60 feet, and may also detect that a preprogrammed path of travel begins 3 feet to the right. The control logic may generate predicted vehicular drive parameters to merge (or “transition”) the autonomous vehicle onto the preprogrammed path of travel. Steering angles at different distances from the boundary can be predicted to cause wheels to turn right incrementally so as to align the autonomous vehicle to at least one of the initial waypoints. Similarly, throttle positions may be reduced to decelerate autonomous vehicle (optionally along with application of one or more brake pressures) to enable the autonomous vehicle to reach a velocity suitable to maintain travel along a preprogrammed path of travel (e.g., without overshooting or erratically following predetermined waypoints).

At 410, a subset of vehicular drive parameters may be applied to guide the autonomous vehicle to a termination point via a preprogrammed (or guided) path of travel. In one example, the subset of vehicular drive parameters may include alternative vehicular drive parameters that may modify a preprogrammed path of travel, for example, when one or more passengers exit an autonomous vehicle and customized parking may be enhanced (e.g., optimized spacing about a parked vehicle). For example, a driver-side door may be positioned and oriented closely to a wall or any other object to maximize space at one or other sides of the autonomous vehicle. In some additional examples, a termination point to which the autonomous vehicle transits may include a location coinciding with either a battery charge station or a battery swap station, or both. As automated driving into battery charge or battery swap stations may involve relatively high magnitudes of voltages and currents that may harm a human, a preprogrammed path of travel to exit or enter a battery charge or swap station may include prerecorded executable instructions that are not alterable by a driver or passenger of the autonomous vehicle. Thus, laypersons may be prohibited from modifying a prerecorded executable set of instructions that are used to position and orient an autonomous vehicle in a specialized configuration, or pose, at a reserved battery charge or swap station.

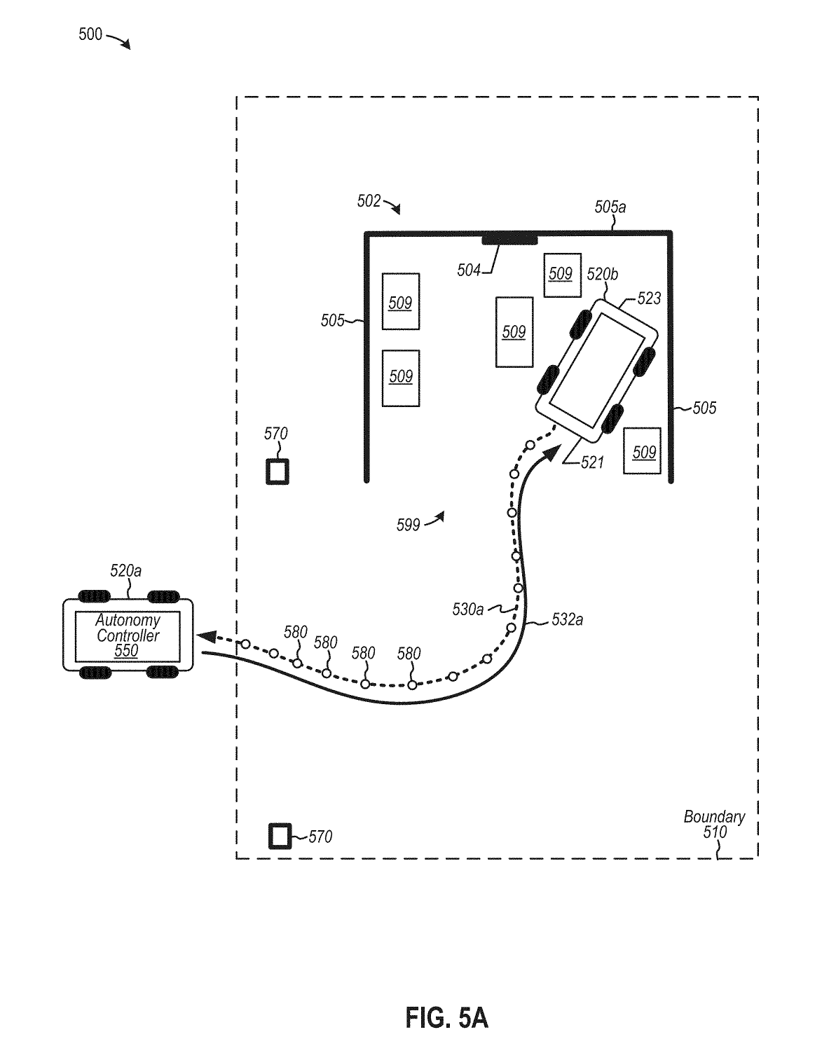

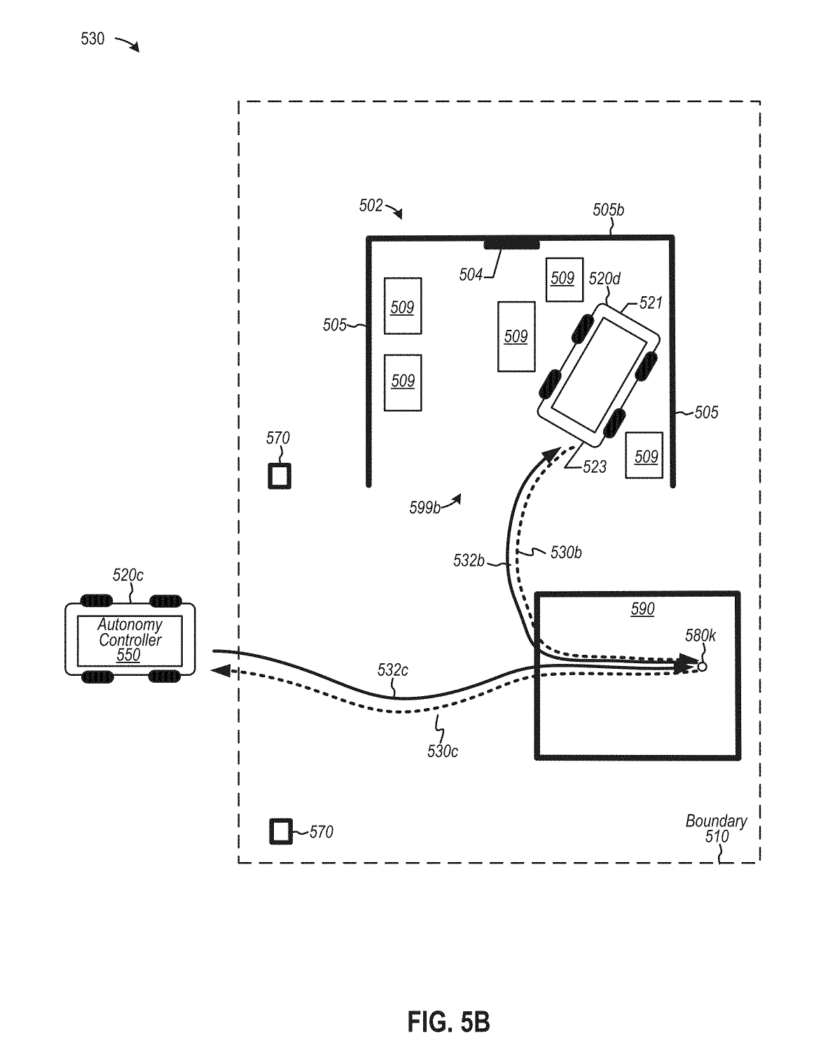

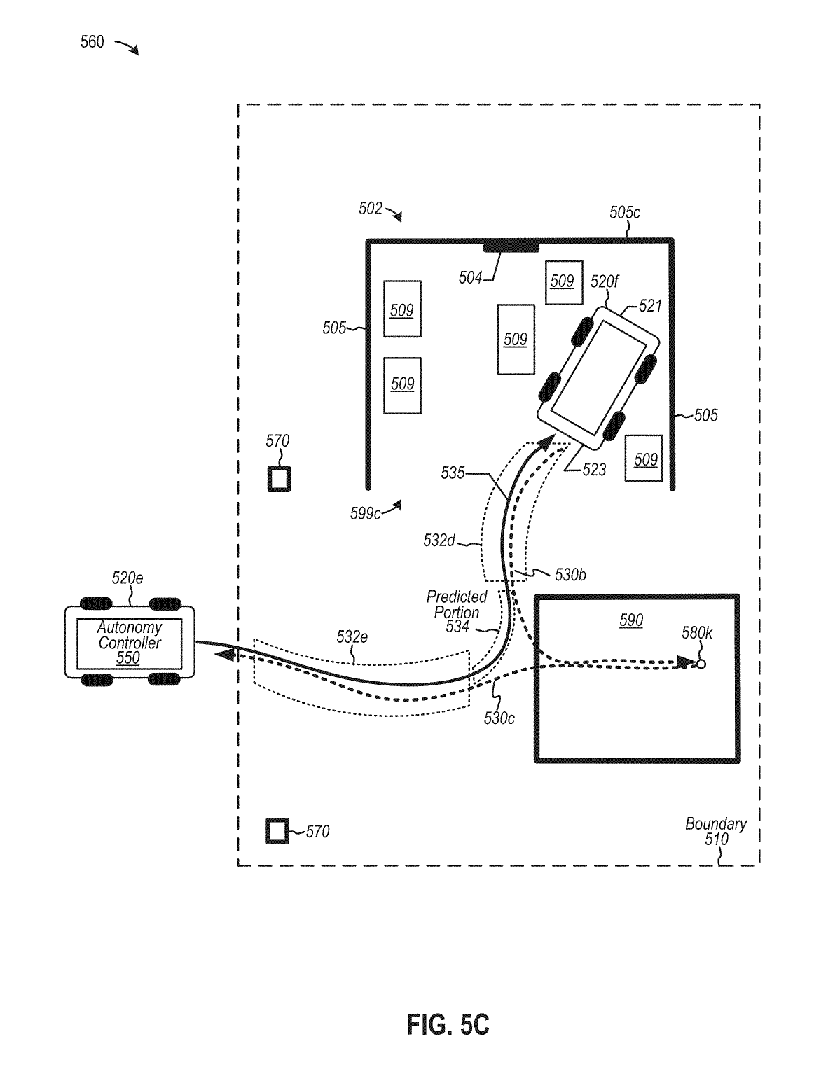

FIG. 5A is a diagram depicting an example of an autonomy controller configured to implement driverless customized parking using a first subset of vehicular drive parameters, according to some embodiments. Diagram 500 depicts an example of an autonomy controller 550 disposed in an autonomous vehicle 520, such as autonomous vehicle 520 at positions 520a and 520b. Diagram 500 also depicts a garage or parking port 502 including walls 505 and an image target 504, all of which are shown disposed in boundary 510. Further, diagram 500 depicts monuments or markers 570, such as a lamp post, a tree, or the like, that may be used to localized autonomous vehicle 520 at position 510a adjacent boundary 510. In the example shown, autonomy controller 550 may be configured to record values of vehicular drive parameters as the values are detected at, for example, units of travel under control of a human driver who may initiate data capture over a path of travel 530a. Further, autonomy controller 550 may be configured to implement captured values of vehicular drive parameters to automatically control displacement of autonomous vehicle 520 to, for example, exit a parking spot at which autonomous vehicle 520b is parked in a customized orientation and position relative to objects 509 at position 520b.

According to some examples, paths of travel 530a and 532a may be determined by capturing vehicular driver parameters at waypoints 580 as autonomous vehicle 520 traverses from position 520b to position 520a. Note that autonomous vehicle 520 may initiate data capture at position 520b, with autonomous vehicle 520 oriented such that anterior portion 521 is adjacent opening 599 of garage 502 and posterior portion 523 is positioned adjacent rear wall 505a. As autonomous vehicle 520 drives along path of travel 530a, under human control, data associated with waypoints 580 may be captured during motion from position 520b (e.g., in forward gear) to position 520b. In some examples, autonomy controller 550 may generate a macro that sequences waypoint data 580 in a reverse sequence. Thus, when executed, autonomous vehicle 520 can traverse in a forward gear via path of travel 532a from position 520a to position 520b. Note that path of travel 532a may be the same as path of travel 530a (but in an opposite direction). Thus, paths of travel 530a and 532a may be formed, optionally, in a single pass, with the same path of travel being used for traversing the same path in both directions as paths of travel 530a and 532a, according at least to some examples.

FIG. 5B is a diagram depicting another example of an autonomy controller configured to implement driverless customized parking using a subset of vehicular drive parameters that include multiple transmission parameters, according to some embodiments. Diagram 530 depicts an example of an autonomy controller 550 disposed in an autonomous vehicle, such as autonomous vehicle 520 at positions 520c and 520d. Diagram 560 also depicts other elements, any of which may include structures and/or functions as similarly-named or similarly-numbered elements depicted in other drawings, or as otherwise described herein, in accordance with one or more examples.

To generate a preprogrammed path of travel, autonomy controller 550 may be configured to record values of vehicular drive parameters as the values are determined at, for example, each unit of travel (e.g., at each waypoint), for example, under control of a human driver who may initiate data capture over a path of travel that includes path portions 530b and 530c. In this example, data capture may be initiated when autonomous vehicle is at position 520d, whereby autonomous vehicle 520 is oriented such that anterior portion 521 is positioned adjacent rear wall 505b and posterior portion 523 is positioned adjacent opening 599b of garage 502. Thus, to exit garage 502, autonomous vehicle 520 drives along path portion 530b in a reverse gear to back out of garage 502 until autonomous vehicle reaches intermediate region 590 at which a transmission gear is shifted from a reverse direction to a forward direction. Changes in directionality of a transmission state (e.g., from reverse to forward) may be captured as data representing vehicular drive parameters at waypoint 580k. Next, data capture may continue as a human driver steers and accelerates autonomous vehicle 520 to transit over path portion 530c in forward gear to exit boundary 510 at position 520c. Note that depictions of waypoints along path portions 530b and 530c are omitted.

Autonomy controller 550 of FIG. 5B may be configured to generate a macro that sequences waypoint data in both in the sequence it was captured and in a reverse sequence. Thus, when executed, autonomous vehicle 520 can traverse in a forward gear via path portion 532c driverlessly when entering boundary 510 from position 520c. Path portion 532c may be the same as path portion 530c from position 520c to position 520d (but in an opposite direction). When autonomous vehicle 520 arrives at waypoint 580k, autonomy controller 550 may automatically shift the transmission from a forward gear to a rear gear in accordance with execution of a macro application using preprogrammed vehicular drive parameters. Next, autonomous vehicle 520 may back into garage 502 via path portion 532b, which may be equivalent to path portion 530b (in an opposite direction), and park in a customized orientation and position with anterior portion 521 adjacent opening 599b (not shown). Thereafter, a macro application may be implemented any number of times to cause autonomous vehicle 520 to driverlessly traverse either path portions 530b and 530c or path portions 532d and 532b. Thus, preprogrammed paths of travel may be formed, optionally, with one pass over a common path of travel, which may be used to traverse path portions 530b and 530c and path portions 532d and 532b, according at least to some examples.

In some examples, a macro may implement preprogrammed path portions 530b and 530c of FIG. 5B when autonomous vehicle 520 to exit garage 102. Further, a modified macro (or another macro) may also be used to implement another preprogrammed path, such as preprogrammed path of travel 532a of FIG. 5A, to facilitate driverless transit of autonomous vehicle 520 to enter garage 102. Accordingly, autonomy controller 550 may be configured to select a preprogrammed path of travel from a subset of preprogrammed paths of travel to facilitate customized parking in garage 102.

FIG. 5C is a diagram depicting yet another example of an autonomy controller configured to predict path portions to implement driverless customized parking, according to some embodiments. Diagram 560 depicts an example of an autonomy controller 550 disposed in an autonomous vehicle, such as autonomous vehicle 520 at positions 520e and 520f. In accordance with the example shown, autonomy controller 550 may be configured to record values of vehicular drive parameters to form a preprogrammed path of travel in a manner similar to that described in FIG. 5B. Hence, vehicular drive parameters may be captured in FIG. 5C via path portions 530b and 530c, which may be equivalent to the path portions of FIG. 5B. Diagram 560 also depicts other elements, any of which may include structures and/or functions as similarly-named or similarly-numbered elements depicted in other drawings, or as otherwise described herein, in accordance with one or more examples.

In this example, however, autonomy controller 550 may be configured to generate a predicted path portion 534 to facilitate driverless transit to a customized parking location in garage 502 over a predicted path of travel 535. For example, autonomy controller 550 may capture vehicular drive parameters at a various waypoints (not shown) on path portions 530b and 530c, similar to that described in FIG. 5B. Autonomy controller 550 may be configured to generate a macro that sequences through waypoint data in portions 532e and 532d in a reverse manner that were captured in portions 530c and 530b, respectively. To omit data representing a change in transmission state at waypoint 580k, autonomy controller 550 may be configured to generate predictive waypoints (and predictive values of vehicular drive parameters) based on waypoint data (not shown) in portions 532e and 532d. For example, predictive values of vehicular drive parameters for predicted portion 534 may include incremental changes in steering/wheel angles, throttle positions, braking pressures, transmission gear states, etc. to generate a preprogrammed portion 534 of a path of travel 535 for seamless transit from captured vehicle driver parameters in portion 532e to captured vehicle drive parameters in portion 532d, the latter of which may be configured to facilitate customized parking in position 520f with anterior portion 521 adjacent wall 505c and posterior portion 523 adjacent opening 599c. Thereafter, autonomy controller 550 may be configured to select any of a preprogrammed path of travel 535, a combination of preprogrammed path portions 530b and 530c, or any other preprogrammed path of travel to facilitate automatic customized parking.

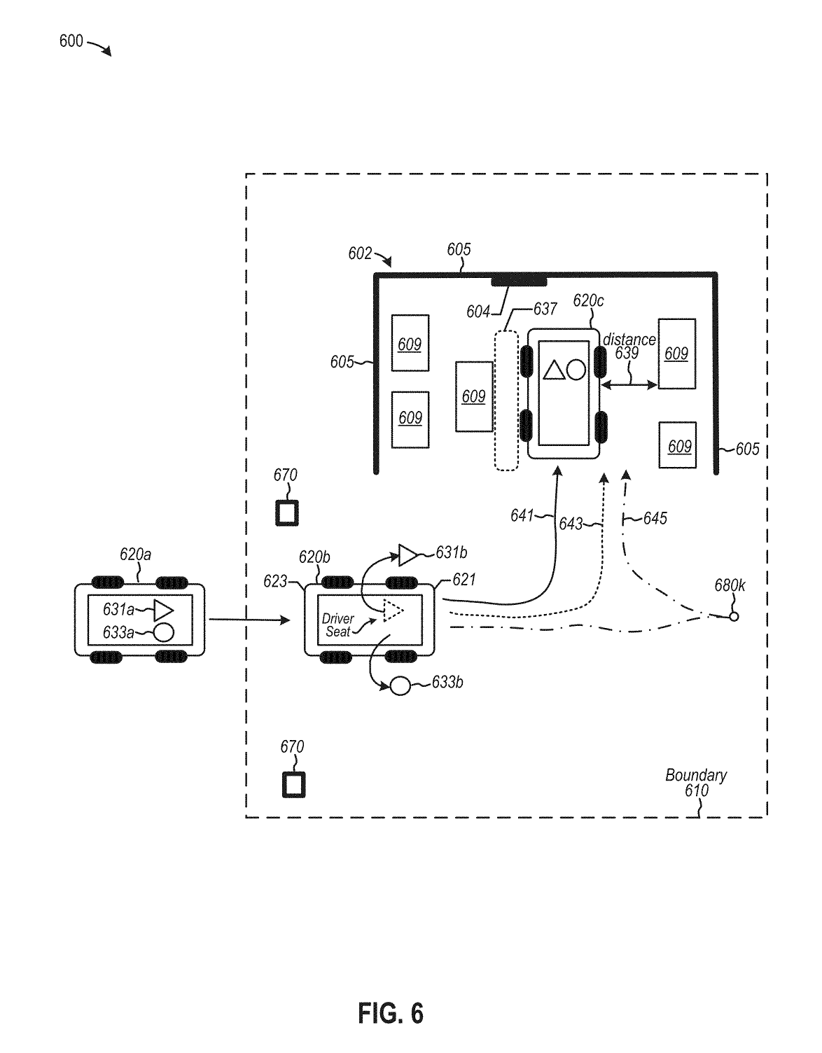

FIG. 6 is a diagram depicting an example of an autonomy controller configured to modify a path of travel to implement driverless customized parking, according to some embodiments. Diagram 600 depicts an example of an autonomous vehicle 620 including an autonomy controller (not shown) that may be configured to form and implement preprogrammed paths of travel to propel autonomous vehicle 620 from position 620a to position 620c, which is a parking location at which autonomous vehicle 620 may be oriented and positioned in accordance, for example, to user preferences.

According to various examples, an autonomy controller may be configured to adapt a functionality of a macro application, or modify a preprogrammed path to facilitate transit of autonomous vehicle 620 driverlessly to position 620c. For example, an autonomy controller may be configured to a modify, responsive to one or more characteristics of autonomous vehicle 620, a preprogrammed path of travel or select one of a number of preprogrammed paths of travel to a customized parking position. Examples of one or more characteristics of autonomous vehicle 620 that may influence selection of a preprogrammed path of travel include data representing a number of passengers (including a driver), data representing whether a passenger may enter or exit autonomous vehicle 620 at a particular side, data representing whether a passenger, including the driver, exits autonomous vehicle 620 during transit of a preprogrammed path of travel, a particular amount of space adjacent a driver or passenger door, and the like. One or more elements depicted in diagram 600 of FIG. 6 may include structures and/or functions as similarly-named or similarly-numbered elements depicted in other drawings, or as otherwise described herein, in accordance with one or more examples.

In the example shown, an autonomy controller may be configured to select (or modify) one of preprogrammed paths of travels 641, 643, and 645 to, for example, optimize an amount of space 637 in garage 602 adjacent one side of autonomous vehicle 620 at position 620c (e.g., to enable a driver to exit the vehicle while maximizing useable space), as well as optimize a distance 639 between another side of autonomous vehicle 620 and an object 609 (e.g., to enable a passenger to exit the vehicle).

To illustrate selection of a path of travel, consider the following example. Autonomous vehicle 620 at position 620a is shown adjacent boundary 610 prior to crossing and transitioning to a preprogrammed path of travel. At position 620a, autonomous vehicle 620 includes a driver 631a and a passenger 633a. Prior to transiting to position 620b, and autonomy controller may be configured to implement preprogrammed path of travel 641 to accommodate driver 631a and passenger 633a when exiting into areas associated with space 637 and distance 639, respectively. However, consider that passenger 633b exits autonomous vehicle at position 620b along path of travel 641. Responsive to determining passenger 633b is absent from autonomous vehicle 620, autonomy controller may be configured to execute instructions to select or modify another preprogrammed path of travel 643, which may be configured to position a side surface portion of autonomous vehicle 620 at distance 639 that may optimize spatial dimensions at space 637 (e.g., adjacent to another side surface portion). Thus, distance 639 may be reduced to, for example, to 2-3 inches, or less, thereby enhancing space 637. As such, autonomous vehicle 620 may terminate transit at a modified pose (e.g., at position 620c) at distance 639.

In another example, consider that both driver 631b and passenger 633b may exit autonomous vehicle 620 at position 620b. Responsive to an absence of all passengers, the autonomy controller may be configured to implement path of travel 645, which includes a directional shifting of transmission gears (e.g., from forward to reverse) at waypoint 680k. As such, autonomous vehicle 620 may back into garage 602 with a driver-side door being at a distance 639 (not shown) from an object 609. Thus, space 637 may be increased by reducing distance 639. Note that the above-described examples are merely illustrative and are not intended to be limiting. Therefore, an autonomy controller may be configured to select any path of travel or any preprogrammed path of travel to facilitate a customized disposition of an autonomous vehicle 620 in accordance with user preferences.

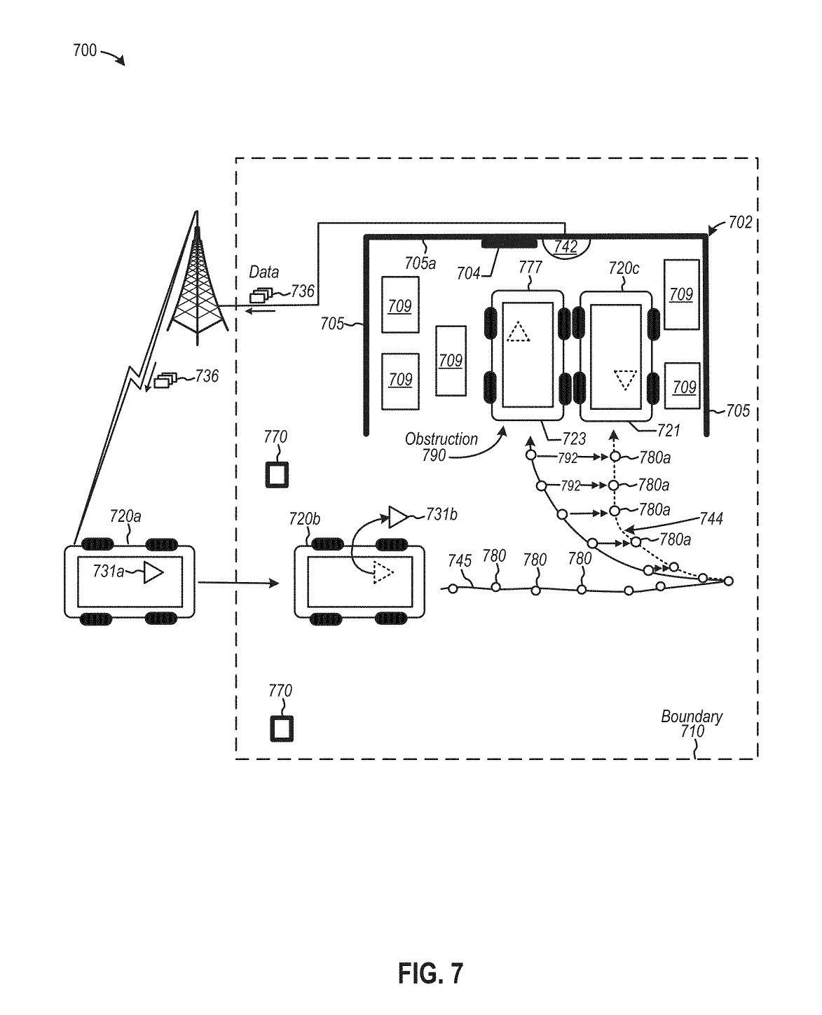

FIG. 7 is a diagram depicting another example of an autonomy controller configured to modify a path of travel to implement driverless customized parking, according to some embodiments. Diagram 700 depicts an example of an autonomous vehicle 720 including an autonomy controller (not shown) configured to implement driverless transit to a parking location at which autonomous vehicle 720 may be oriented and positioned in accordance, for example, to user preferences. One or more elements depicted in diagram 700 of FIG. 7 may include structures and/or functions as similarly-named or similarly-numbered elements depicted in other drawings, or as otherwise described herein, in accordance with one or more examples.

According to various examples, an autonomy controller may be configured to receive data 736 via one or more networks from a device 742 including one or more sensors to monitor spatial changes within a garage 702 that may impede or interfere with parking. For example, during time periods in which autonomous vehicle 720 is traveling outside boundary 710, one or more other persons with access to garage 702 may move objects 709 or park another vehicle 777 within garage 702. A moved object 709 or parked vehicle 777 may be an obstruction 790 that may prevent autonomous vehicle 720 from being able to park in an orientation and position associated with preprogrammed path of travel 745. Device 742 may include any sensor implemented in autonomous vehicle 720, such as a camera, radar, lidar, etc. Device 742 also may include a processor and memory configured to generate executable instructions to change or update a macro application and a preprogrammed path of travel that may be affected by obstruction 790. Device 742 may transmit data 736 representing either spatial data associated with garage 702 or updated executable instructions, or both. Data 736 may be used by an autonomy controller to modify a functionality of a macro application to implement a modified preprogrammed path of travel 745 to park in a customized orientation and position at position 720c.

Consider the following example in which device 742 generates data 736 that indicates vehicle 777 has pulled into garage 702 to park. Hence, vehicle 777 is an obstruction 790 to driverless parking via preprogrammed path of travel 745. Vehicle 777 is shown to be oriented such that posterior portion 723 is adjacent to garage opening. Data 736 may be transmitted to the autonomy controller on-board autonomous vehicle 720 at position 720a. Prior to entering boundary 710, the autonomy controller can be configured to detect impeding object 777 on a second path portion disposed at a location coinciding with a parking port (e.g., garage 702). Based on data 736, the autonomy controller may determine garage 702 has sufficient space at position 720c at which autonomous vehicle 720 may park. To implement preprogrammed path of travel 745, the autonomy controller may identify waypoints that may be modified to form predicted waypoints 780a, which, in turn, may form a predicted path portion 744 over which autonomous vehicle 720 may traverse driverlessly into garage 702. As an example, the autonomy controller may predict an amount of displacement 792 from waypoints on a portion of 745 to predicted waypoints 780a. Further, autonomy controller may also predict changes to steering/wheel angles, braking pressures, throttle positions, transmission gear states, etc. for each of predicted waypoints 780a to facilitate transit, in reverse gear, over predicted path portion 744 so that autonomous vehicle 720 backs into garage 702 to park at position 720c. In some cases, predicted path portion 744 may cause the autonomy controller to generate a notice (e.g., via a user interface) to exit autonomous vehicle 720 at position 731b to effect driverless parking. Hence, data 736 may be used to generate predicted path portion 744 (as a modified path of travel at a path portion 744 of path of travel 745) that may be used to automatically terminate transit at an alternate pose in a parking spot. In some examples, implementing predicted waypoints 780a may provide more precise and accurate determinations to park autonomous vehicle 720 driverlessly than otherwise might be the case in some situations (e.g., use of generated trajectories).

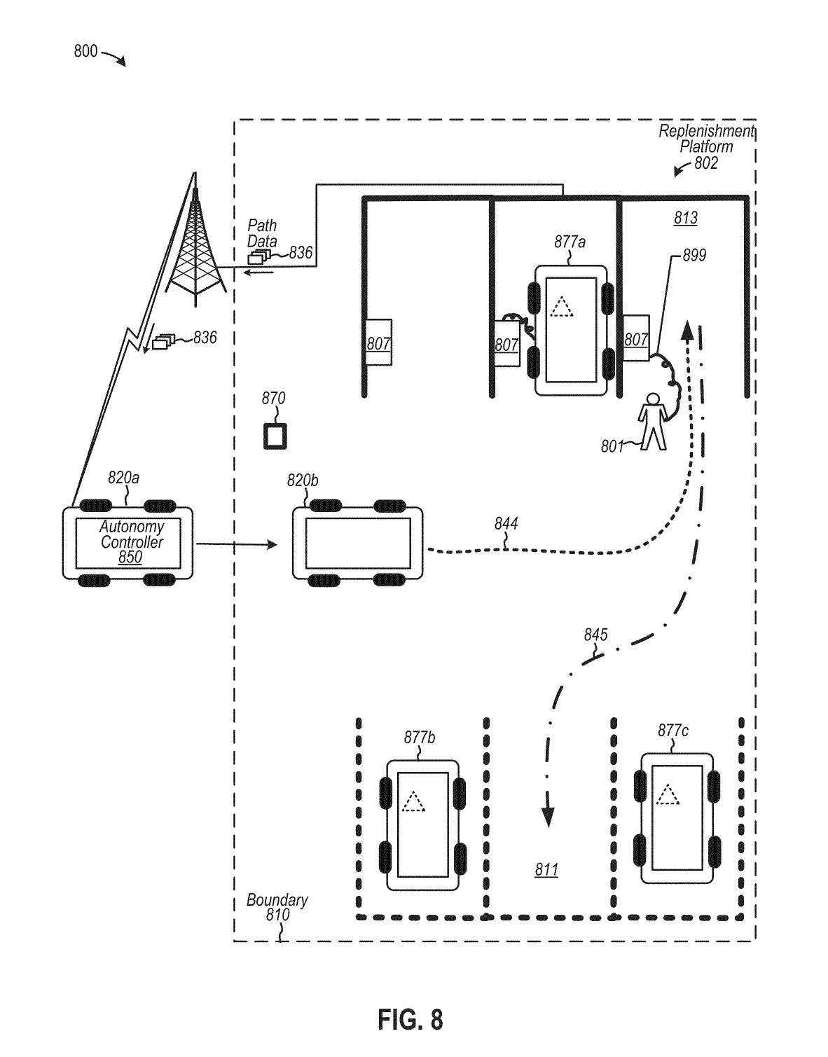

FIG. 8 is a diagram depicting an example of an autonomy controller configured to implement a preprogram path of travel to implement a driverless approach to a fuel replenishment station, according to some embodiments. Diagram 800 depicts an example of an autonomous vehicle 820 that includes an autonomy controller (not shown) that is configured to implement driverless transit on approach to a fuel replenishment station 807, whereby the driverless approach may be influenced by a preprogrammed path of travel formed to minimize or negate risk of inadvertent collision or accidents with fuel replenishment station. Such stations may include various hazards, including high voltages and currents, volatile fuel (e.g., hydrogen, liquid natural gas, etc.), and the like. One or more elements depicted in diagram 800 of FIG. 8 may include structures and/or functions as similarly-named or similarly-numbered elements depicted in other drawings, or as otherwise described herein, in accordance with one or more examples.

Diagram 800 depicts a replenishment platform 802 disposed in a boundary 810 and including at least two or more fuel replenishment stations 807. Examples of fuel replenishment stations include electric charging stations, hydrogen fueling stations, liquid natural gas stations, etc. In the example shown, fuel replenishment stations 807 may be implemented as “charging stations” with which an amount of fuel may be dispensed in units of fuel, such in units of battery charge or energy (or the equivalent thereof). An amount of charge may be expressed in kilowatts-hours (“kWh”), ampere-hours (“A-hr”), or the like.

Autonomy controller 850 may transition from implementing real-time generation of trajectories from which to select a path segment to travel along a roadway, such as at position 820a. Vehicular drive parameters then may be derived based on a selected trajectory. As autonomous vehicle 820 approaches boundary 810, autonomy controller 850 may be configured to implement a preprogrammed path of travel, such as path of travel 844, with which to guide transit of autonomous vehicle 820 to a charging bay 813 from position 820b. In some examples, data representing any number of preprogrammed paths of travel may be stored on-board autonomous vehicle 820 for use in navigating autonomous vehicle 820 to any of charge bays 813. In additional examples, autonomy controller 850 may be configured to receive via a wireless network data 836 representing a macro application and/or a preprogrammed path of travel over which autonomous vehicle 820 is authorized to transit. A preprogrammed path of travel 844 transmitted as data 836 may include data representing particular waypoints associated with geographic locations, as is determined by GPS or any odometry techniques. Further, preprogrammed path of travel 844 may include vehicular drive parameters (e.g., steering/wheel angles, transmission gear states, throttle position, etc.) adapted for the particular model of autonomous vehicle 820. Different models of autonomous vehicles may have different dimensions, and may also have different mechanical responses to different values of vehicular drive parameters. For example, a turning radius for one model of autonomous vehicle may differ from another model of autonomous vehicle. Thus, a macro application may be adapted to particular model of autonomous vehicle 820 to facilitate relatively accurate and precise travel over preprogrammed path of travel 844. The adaptive macro application may include executable instructions to orient and position autonomous vehicle 820 driverlessly (e.g., without a driver or any passenger) adjacent to charging station 807 in charging bay 813 to accept a fuel interface (e.g., a plug of a charging cable) to receive fuel (e.g., electric charge or power). In some examples, a human driver in autonomous vehicle 820 may provide control inputs to drive into charging bay 813, which is adjacent another charging bay including vehicle 877a.

According to some examples, autonomous vehicle 820 may be coupled to charging station 807 via charging cable 899. When an amount of fuel units (e.g., amount of charge) reach a certain level of charge indicating that a battery has sufficient stored energy to propel autonomous vehicle 820 over a minimum distance in normal traffic conditions, autonomy controller 850 may be configured to deactivate a lock (e.g., an electromagnetic locking mechanism) that affixes charge cable 899 to autonomous vehicle 820 during refueling (e.g., during battery charging). Another user 801 or service personnel may disconnect cable 899 from autonomous vehicle 820 if the owner/driver of autonomous vehicle 820 is not present. In some examples, autonomous vehicle 820 may produce visual or audio messages alerting persons nearby that autonomous vehicle 820 has “completed charging” and a next user 801 is invited to “remove cable 899” to vacate charging bay 813. Upon detecting disconnection of cable 899, autonomy controller 850 may be configured to exit charging bay 813 driverlessly via path of travel 845 to park in location 811, among other vehicles 877b and 877c. In some cases, path of travel 845 may be implemented by execution of a macro application. Autonomy controller 850 therefore may be configured to free up charging bay 813 so as to enable other users to access charging bay 813 to reduce downtime and increase throughput, which also enhances users' experiences collectively. Alternatively, autonomous vehicle may return driverlessly to its point of geographic origination, such as a user's driveway at a residence.

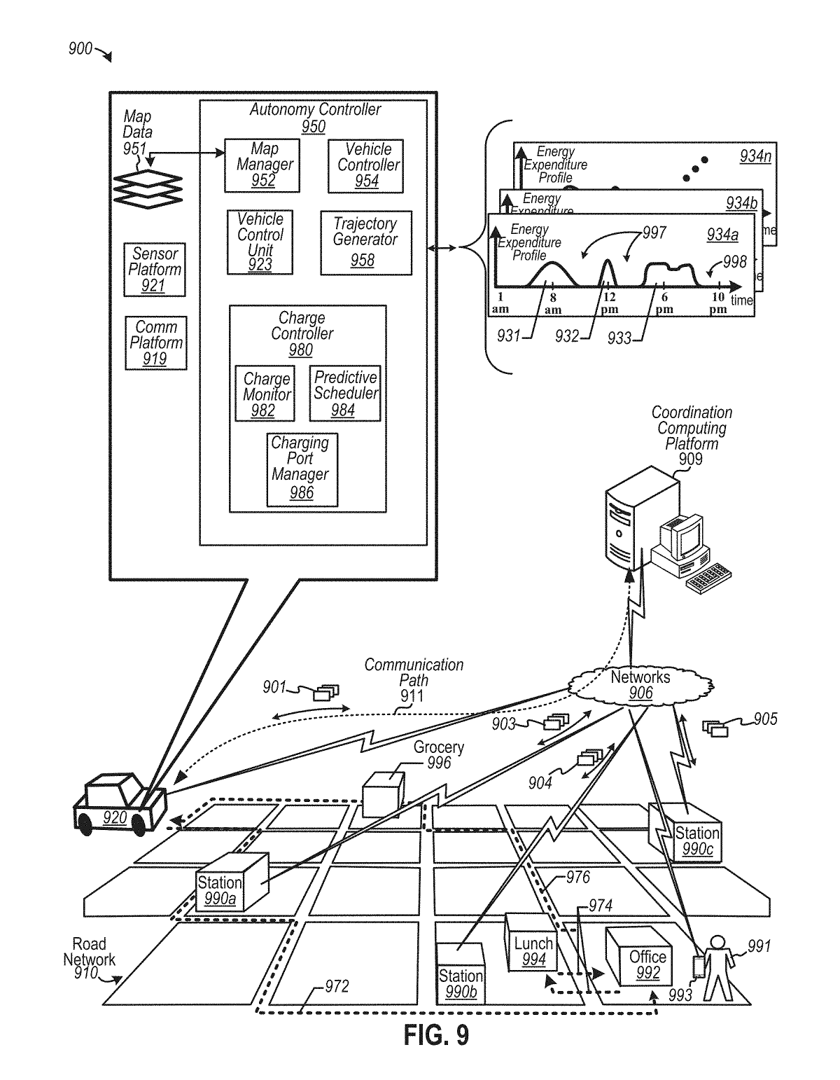

FIG. 9 is a diagram depicting an example of an autonomy controller configured to coordinate driverless transit to a fuel replenishment station, according to some embodiments. Diagram 900 depicts an example of an autonomous vehicle 920 including an autonomy controller 950, a sensor platform 921, and a communication platform (“comm platform”) 919. Communication platform 919 may be a communication facility that includes a transceiver device (e.g., RF transmitters and receivers) configured to exchange data and electronic messages wirelessly via an antenna (not shown). In the example shown, communication platform 919 may be configured to implement a communication path 911 to exchange electronic messages between autonomous vehicle 920 and a coordination computing platform 909 via one or more networks 906. Coordination computing platform 909 may be configured to coordinate scheduling fuel replenishment for an autonomous vehicle 920, which may travel to a particular replenishment station driverlessly at optimal intervals of time. An optimal interval of time may include a time period during which autonomous vehicle 920 may be idle. For example, an owner/passenger/occupant may not need to use autonomous vehicle 920 during a period of time when performing non-travel related activities such as sleeping, working, or performing any other activity external to autonomous vehicle 920.

Autonomy controller 950 may be configured to monitor levels of fuel (e.g., levels of charge or energy, if electric battery-powered), predict an optimal time at which to recharge a battery, and schedule a charging session at a particular charging station. Autonomy controller 950 is shown to include a map manager 952 to manage map data 951, a vehicle controller 954, a vehicle control unit 923, a trajectory generator 958, and a charge controller 980. One or more elements depicted in diagram 900 of FIG. 9 may include structures and/or functions as similarly-named or similarly-numbered elements depicted in other drawings, or as otherwise described herein, in accordance with one or more examples.

Charge controller 980 is shown, at least in this example, to include a charge monitor 982, a predictive scheduler 984, and a charging port manager 986. According to some examples, charge controller 980 may be configured to monitor charge or energy levels of a battery relative to, for example, one or more thresholds and predict an interval of time during which to activate driverless recharging so that a battery may be recharged sufficiently to propel autonomous vehicle 920 over a range of distances to accomplish planned or predicted activities (e.g., traveling to an office, a restaurant, a grocery store, and returning home). Driverless recharging may include controlling autonomous vehicle 920 to transit driverlessly to and from a charging station, and to engage a charging station to replenish an amount of battery energy.

Charge monitor 982 may be configured to monitor an amount of fuel units against data representing a threshold indicative of a portion of fuel reservoir capacity. If autonomous vehicle 920 includes a battery, charge monitor 982 may be configured to determine “an amount of charge” (as an amount of fuel units) that may be stored in one or more batteries relative to a total capacity of charge that batteries may store (e.g., a “fuel reservoir capacity”). Data representing an amount of fuel units may be expressed in terms of kilowatts-hours (“kWh”), ampere-hours (“A-hr”), or the like to specify an amount of charge or energy that may be replenished, recharged, or added to the one or more batteries. In some examples, charge monitor 982 may determine levels of charge or energy against any number of thresholds. A first threshold may represent a critical level, such as a level representing one-eighth or one-sixteenth of the total charge capacity, such that charge monitor 982 may generate a data signal representing a critical level of charge. In at least one case. A second threshold may represent one level of charge or energy against which a battery level may be compared to determine whether the level of charge is sufficient to propel or power autonomous vehicle 920 to perform the subset of planned or predicted activities during a period of time (during the time when a driver/passenger/occupant is awake). The second threshold represents a level of charge for accomplishing a user's transportation goals without intervening recharge, at least in some examples. Charge monitor 982 can generate a data signal indicating the second threshold is crossed upon detection. Other threshold levels may be implemented.

Predictive scheduler 984 may be configured to determine or predict an amount of fuel expenditure (e.g., charge or energy depletion) of autonomous vehicle 920 during a range of time, such as during a weekday in which a user may use autonomous vehicle 920 to transit via route 972 in a road network 910 (e.g., a network of roadways) to arrive an office 992 at which the user performs work-related activities. Fuel expenditure may also include a predicted depletion of charge during transit to and from a restaurant 994 for lunch via routes 974. Further, charge or energy may be expended as user is transported in autonomous vehicle 920 over route 976 to a grocery store 996 prior to transiting home. As an example, the above-described predicted fuel expenditure may be predicted and stored as data representing an energy expenditure profile, such as profiles 934a, 934b, and 934n. Data representing energy expenditure profile 934a may describe predictive rates of energy expended, such as amounts 931, 932, and 933 during intervals of time associated with profile 934a. Further to the example shown, a first amount of predicted energy expended to travel route 972 may be represented as an amount 931 around 8 am, a second amount of predicted energy expended to travel routes 974 are represented as an amount 932 between 12 pm and 1 pm, and a third amount of predicted energy expenditure travel route 976 (e.g., between 5 pm and 8 pm).

Predictive scheduler 984 may also be configured to calculate a total predicated energy expenditure based on a combination of energy expenditures 931, 932, and 933, and may be further configured to determine whether the total predicated energy expenditure may be equivalent to or above a threshold, such as the above-described second threshold. For example, charge monitor 982 may be configured to transmit the data signal specifying an amount of charge stored in a battery. Predictive schedule 984 may determine that the calculated total amount of energy expenditure over time intervals associated with amounts 931, 932, and 933 is less than amount of energy depletion that may cause the charge the battery to drop below the second threshold. Thus, in cases in which the total calculated energy expenditure to travel routes 972, and 974, and 976 is less than amount of charge that may drop below a threshold, then driverless recharging activities may be reserved to over-night hours 998 when a user/driver/passenger/occupant is asleep.

But in cases in which a calculated total energy expenditure to travel routes 972, and 974, and 976 may cause a battery level to fall below the second threshold, a supplemental replenishment or recharge may be sought to ensure a user may complete its travel to office 992, restaurant 994, and grocery store 996 before returning home. To implement supplemental charging, predictive scheduler 984 may be configured to identify a subset of time periods as a candidate time frame to replenish at least a portion of a fuel reservoir capacity (e.g., to supplement a level of charge on a battery) to enable autonomous vehicle 920 to travel routes 972, 974, and 976. For example, one or more intervening time periods 997 may be identified as candidate time frames during which autonomous vehicle 920 is idle (or vacant). So while autonomous vehicle 920 may be idle during time periods 997, autonomous vehicle 920 may be activated to travel driverlessly to one of charging stations 990a, 990b, and 990c to replenish an amount of charge, and to return driverlessly.

Predictive schedule 984 may be further configured to reserve a charging station during candidate time frames 997 to recharge at least a portion of the capacity level of a battery. Predictive schedule 984 may be configured to cause autonomy controller 950 to transmit an electronic message 901 from autonomous vehicle 920 to a coordination computing platform 909 to coordinate and reserve a replenishment station at a specific time associated with one of candidate time frames 997. For example, autonomy controller 950 may transmit data 901 as a reservation request via communication path 911, the request being configured to reserve a replenishment station in a network of replenishment stations 990a, 990b, and 990c as a function of, for example, candidate time frames 997 and a predicted fuel expenditure (e.g., an amount of charge to supplement a battery, which may be associated with a time period to complete the recharge of at least a portion of a capacity of a battery). In some examples, request data 901 may include autonomous vehicle (“AV”) data representing autonomous vehicle characteristics with which to determine the replenishment station. Examples of autonomous vehicle characteristics include a model or type of autonomous vehicle 920 (including the dimensions and mechanical performance characteristics, such as turning radii), a type of power plant (e.g., whether a combustion engine, electric motor, etc.), a type of fuel (e.g., electricity, hydrogen, liquid natural gas, diesel, biofuel, etc.), a type of replenishment interface (e.g., a type of connector, such as a NEMA or SAE J1772 connector), a type of pricing (e.g., free or paid, and if paid, “per hour” pricing, “per session” pricing, “per unit power usage,” such as kWh, etc.), one or more time intervals in which an autonomous vehicle is available for driverless charging, and the like.

Coordination computing platform 909 may be configured to coordinate reservation of charging of autonomous vehicle 920 at preferable intervals of time (e.g., during periods when autonomous vehicle is idle). In particular, coordination computing platform 909 may include executable instructions to receive characteristics of replenishment stations (or charging stations) 990a, 990b, and 990c as station data 903, 904, and 905, respectively. In some examples, station data 903, 904, and 905 may include one or more of the following station characteristics: a unique station identifier, a charging station manufacturer name, a pricing model (e.g., free or paid, and if paid, “per hour” pricing, “per session” pricing, “per unit power usage,” such as kWh, etc.), a geographic location of a charge station (e.g., latitude and longitude coordinates), a supported voltage (e.g., 120 v or 240 v), a support current (e.g., 16 A, 32 A, 63 A, 100-125 A, 300-350 A, etc.), an amount of power supported (kW), a cable connector or interface type, one or more levels and/or rates of charging available at a charging station (e.g., “level 1” charging, such as 120V/16 A at about 4 miles per hour charging via NEMA outlet connector; “level 2” charging, such as 240V/80 A at about 70 miles per hour charging; “level 3” charging, such as DC Fast Charging at 240V and 400 A; and the like), an indication whether a charging station is in use, relevant reservation data for a charging station, etc. Coordination computing platform 909 may include either hardware or software, or a combination thereof, and may implement one or more servers and memory devices, regardless whether distributed over any number of geographic locations.

Coordination computing platform 909 further may be configured to compare autonomous vehicle characteristic 901 data against station data 903, 904, and 905 associated with a pool of charging stations 990a, 990b, 990c, among others, to identify a subset of station data for charging stations that may be available to reserve for autonomous vehicle 920. Thus, station data 903, 904, and 905 from one or more charging stations in the subset of station data may be transmitted, as a list of replenishment stations, for presentation on an interface in autonomous vehicle 920 or a user device 993 (e.g., mobile computing device or phone). For example, a user 991 may be presented a list of charging stations from which to select for performing driverless charging. Coordination computing platform 909, therefore, may be detect a user input originating at a user device 993 in data representing a selected replenishment station. In turn, mobile computing device 993, or the like, may be configured to transmit a confirmatory electronic message to autonomy controller 950 to enable driverless transit to receive fuel replenishment at a scheduled time. Thus, user 991 in office 992 may communicate with logic in autonomous vehicle 920 to monitor and control driverless charging. At a scheduled time, autonomy controller 950 may be configured to activate autonomous vehicle 920 to drive autonomously to a geographic location to receive fuel replenishment, such as station 990c. Once charging is complete, autonomous vehicle 920 may drive back to its original location driverlessly (e.g., back to a parking lot of office 992).

Charging port manager 986 may be configured to monitor a rate of charging to detect when charging is complete. Once completed, charging port manager 986 may be configured to generate a control signal to release a lock affixing a charge cable to autonomous vehicle 920, similar to that described in FIG. 8. Note that upon receiving a critical data signal specifying a level of charge in a battery is critical, autonomy controller 950 may be configured to omit scheduling and automatically transit to a charging station upon authorization by a user. Note, too, while charge controller 980 may be configured to recharge an electric battery of an autonomous, controller 980 may be implemented to monitor levels of any type of fuel, such as hydrogen, liquid natural gas, gasoline, diesel, biofuels, and the like.

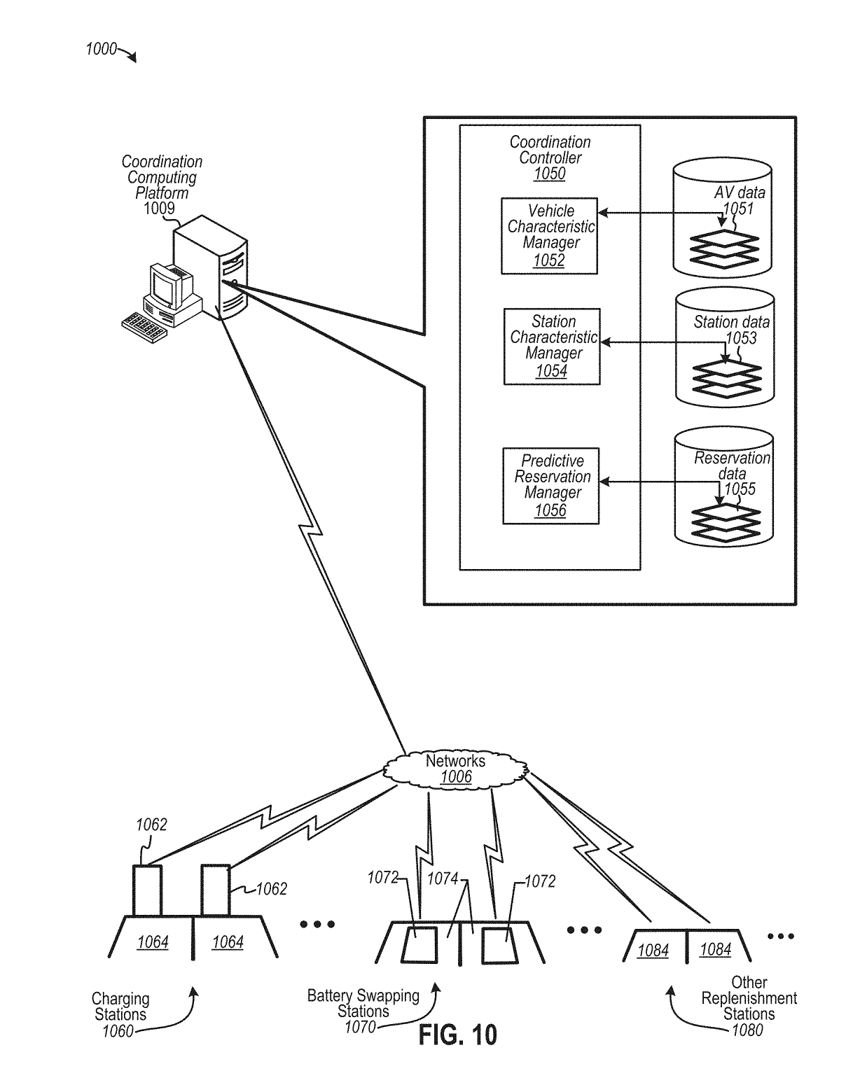

FIG. 10 is a diagram depicting an example of a coordination computing platform configured to coordinate driverless transit to a fuel replenishment station, according to some embodiments. Diagram 1000 depicts a coordination computing platform 1009 communicatively coupled via one or more networks 1006 to fuel replenishment stations, such as charging stations 1062, battery swapping stations 1070, and other types of replenishment stations 1080, each of which may include a processor and memory to store executable instruction, including an API to communication with coordination controller 1050. Charging stations 1060 include a charging station 1062 for each parking bay 1064. Battery swap stations 1070 include a below-ground battery swap station 1072 in each parking bay 1074. Other devices to facilitate other methods of battery swapping may be implemented in parking bay 1074, too. Other appointments stations 1080 may include any other type of fuel replenishment station (e.g., hydrogen) in each parking bay 1084. One or more elements depicted in diagram 1000 of FIG. 10 may include structures and/or functions as similarly-named or similarly-numbered elements depicted in other drawings, or as otherwise described herein, in accordance with one or more examples.

Further to diagram 1000, coordination computing platform 1009 is shown to include a coordination controller 1050, which, in turn, may include a vehicle characteristics manager 1052, a station characteristic manager 1054, and a predictive reservation manager 1056, each of which may include logic implemented in hardware or software, or a combination thereof. Vehicle characteristics manager 1052 may be configured to store autonomous vehicle characteristics data 1051, and further configured to monitor changes in autonomous vehicle characteristics data 1051. For example, vehicle characteristics manager 1052 may receive updates as to a charge level of an autonomous vehicle so that, for example, coordination controller 1050 may modify a reserve charging station to offer another charging station at a reduced distance if the charge level is decreasing at faster rate than when an initial reservation was made. Station characteristic manager 1054 may be configured to store station data 1053, which may be updated in real-time (or substantially in real-time) to reflect changes, for example, in availability of a charging station, or any other changes in status. Predictive reservation manager 1056 may be configured to store reservation data 1055, which may be based on matched autonomous vehicle data 1051 and station data 1053. As such, reservation data 1055 may include a subset of charging station suitable filtered from a larger pool of replenishment stations. Predictive reservation manager 1036 may also be configured to monitor changes in reservation data 1055 to optimize presentation of a list of most suitable charging stations for autonomous vehicle so that a user may have real-time information with which to select or authorize a particular charging station to effect driverless charging.

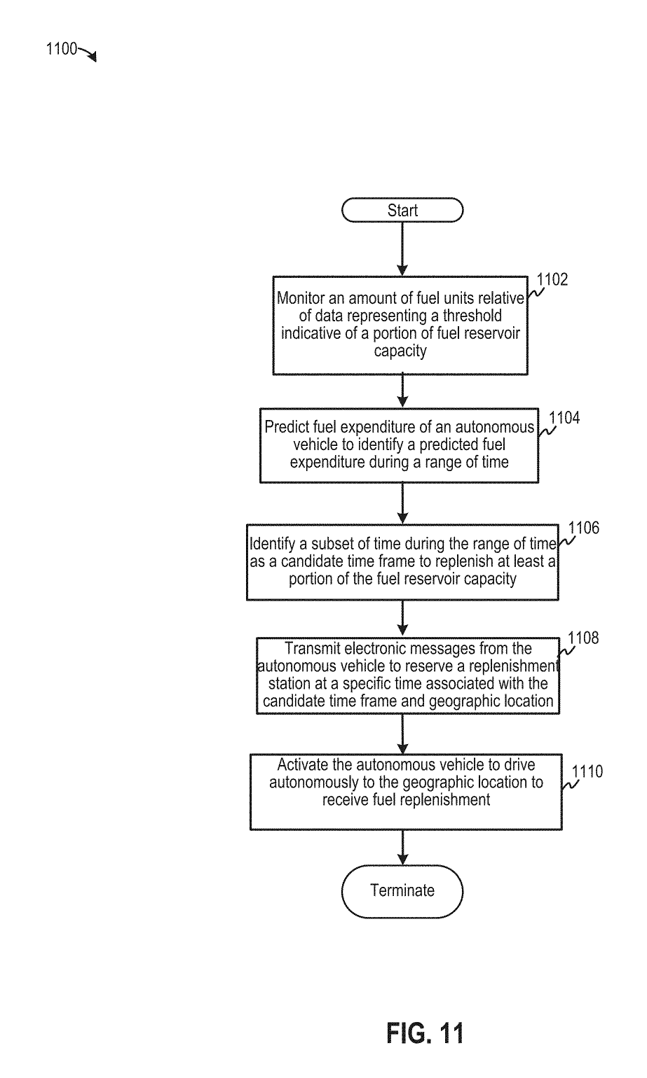

FIG. 11 is a flow diagram depicting an example of determining whether to coordinate driverless transit to a fuel replenishment station, according to some embodiments. At 1102, flow 1100 begins by monitoring an amount of fuel units relative of data representing a threshold indicative of a portion of fuel reservoir capacity. In recharging batteries, a “fuel reservoir capacity” may be expressed as a total amount of charge or energy that may be stored in one or more batteries, and “an amount of fuel units” may expressed in terms of kilowatts-hours (“kWh”), ampere-hours (“A-hr”), or the like, to specify an amount of energy that is replenished or added to the one or more batteries. In some examples, a charge controller may be configured to monitor whether an amount of charge falls below a “threshold” indicating a remaining amount of charge is less than may be sufficient to travel to one or more different geographic locations. When the charge level falls below the threshold, the charge monitor may trigger generation of a signal to initiate scheduling of replenishment of a battery. In some cases, the threshold may be static (e.g., one-quarter amount of total charge or energy capacity of a battery) or dynamic (e.g., an amount of charge or energy to perform predicted or requested travel actions, such as driving home from work and stopping a grocery store on the way home).

At 1104, fuel expenditure of an autonomous vehicle may be predicted to accomplish certain actions, such as propelling the autonomous vehicle to multiple destinations to achieve certain objectives during a range of time. Examples of tasks that may need energy to propel a vehicle include tasks like purchasing a meal, such as lunch, purchasing groceries or hardware, transporting children to and from school, and the like. Further, an amount of fuel expenditure may be calculated to cause the threshold to be crossed, and, as such, an amount of battery energy or charge to offset the expenditure may be computed for at least replenishing the charge or energy, thereby ensuring the predicted expenditure may avoid depleting amount of charge or energy below the threshold.

At 1106, a subset of time during a range of time may be identified as a candidate time frame to replenish at least a portion of a fuel reservoir capacity. For example, a location and distance of a replenishment station may be determined, an amount of time to transit to and from the replenishment station may be determined, an amount of charge that may be depleted during the round trip may be determined, a time to charge a battery to a certain level of charge or energy may be predicted, and other factors may be considered. Therefore, if there is sufficient time to replenish charge or energy (e.g., sufficient time for round-trip driverless transit to and from the charge station and a total predicted charging time), the time frame in which to replenish charge or energy may be identified as a candidate time frame.

At 1108, electronic messages may be transmitted from an autonomous vehicle to reserve a replenishment station (e.g., a charging station) to replenish at least a portion of the fuel reservoir capacity, such as charging a battery to add at least an additional amount of charge or energy to the total battery capacity. A computing device in communication with the charging station may receive data representing the reservation to limit access and authorization to an autonomous vehicle associated with the reservation. At 1110, an autonomous vehicle may be activated to drive autonomously (e.g., driverlessly without a driver) to a geographic location associated with a charging station. Therefore, an autonomy controller may be configured to predict an amount of charge or energy to replenish a battery so that a number of predicted activities may be accomplished during a particular time frame. Further, the autonomy controller may also be configured to coordinate charging without a human driver or passenger during, for example, a time frame during which a passenger or driver may not use the autonomous vehicle for transportation.

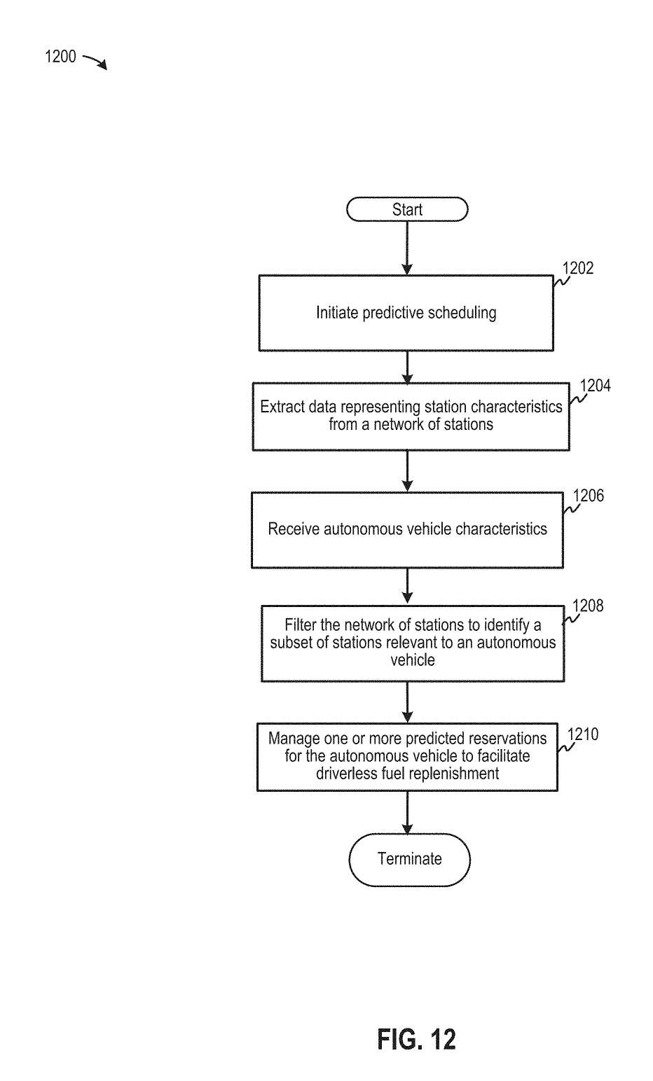

FIG. 12 is a flow diagram depicting an example of coordinating driverless transit to a fuel replenishment station, according to some embodiments. At 1202, predictive scheduling may be initiated at, for example, a coordination computing system that may be in networked communication with any number of geographically distributed fuel replenishment stations (e.g., charging stations). In some examples, and autonomous vehicle may transmit electronic message requesting a reservation generally or any specific charging station or site.

At 1204, data representing station characteristics, as described in FIG. 9, for any number of replenishment stations in a network of stations may be extracted. At 1206, characteristics associated with a particular autonomous vehicle requesting fuel replenishment or charging services may be received. At 1208, a number of networked replenishment stations may be analyzed so as to compare station characteristics against the autonomous vehicle characteristics to filter out a subset of charging stations that may be relevant to the particular autonomous vehicle. At 1210, at least one predicted reservation may be determined based on the subset of charging stations. A selected predicted reservation may be managed for the autonomous vehicle to facilitate driverless fuel replenishment.

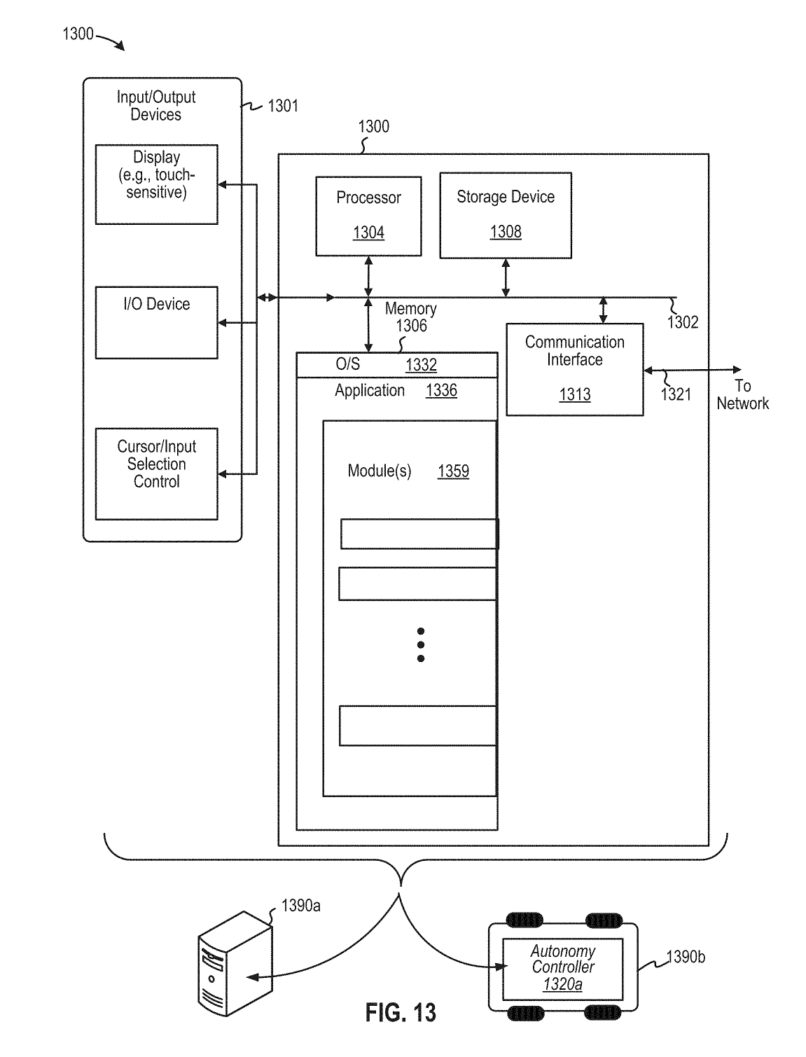

FIG. 13 illustrates examples of various computing platforms configured to provide various functionalities to components of an autonomy controller, according to various embodiments. In some examples, computing platform 1300 may be used to implement computer programs, applications, methods, processes, algorithms, or other software, as well as any hardware implementation thereof, to perform the above-described techniques.

In some cases, computing platform 1300 or any portion (e.g., any structural or functional portion) can be disposed in any device, such as a computing device 1390a, autonomous vehicle 1390b, and/or a processing circuit in forming structures and/or functions of a an autonomy controller 1320a, according to various examples described herein.

Computing platform 1300 includes a bus 1302 or other communication mechanism for communicating information, which interconnects subsystems and devices, such as processor 1304, system memory 1306 (e.g., RAM, etc.), storage device 1308 (e.g., ROM, etc.), an in-memory cache (which may be implemented in RAM 1306 or other portions of computing platform 1300), a communication interface 1313 (e.g., an Ethernet or wireless controller, a Bluetooth controller, NFC logic, etc.) to facilitate communications via a port on communication link 1321 to communicate, for example, with a computing device, including mobile computing and/or communication devices with processors, including database devices (e.g., storage devices configured to store atomized datasets, including, but not limited to triplestores, etc.). Processor 1304 can be implemented as one or more graphics processing units (“GPUs”), as one or more central processing units (“CPUs”), such as those manufactured by Intel® Corporation, or as one or more virtual processors, as well as any combination of CPUs and virtual processors. Computing platform 1300 exchanges data representing inputs and outputs via input-and-output devices 1301, including, but not limited to, keyboards, mice, audio inputs (e.g., speech-to-text driven devices), user interfaces, displays, monitors, cursors, touch-sensitive displays, LCD or LED displays, and other I/O-related devices.

Note that in some examples, input-and-output devices 1301 may be implemented as, or otherwise substituted with, a user interface in a computing device associated with a user account identifier in accordance with the various examples described herein.

According to some examples, computing platform 1300 performs specific operations by processor 1304 executing one or more sequences of one or more instructions stored in system memory 1306, and computing platform 1300 can be implemented in a client-server arrangement, peer-to-peer arrangement, or as any mobile computing device, including smart phones and the like. Such instructions or data may be read into system memory 1306 from another computer readable medium, such as storage device 1308. In some examples, hard-wired circuitry may be used in place of or in combination with software instructions for implementation. Instructions may be embedded in software or firmware. The term “computer readable medium” refers to any tangible medium that participates in providing instructions to processor 1304 for execution. Such a medium may take many forms, including but not limited to, non-volatile media and volatile media. Non-volatile media includes, for example, optical or magnetic disks and the like. Volatile media includes dynamic memory, such as system memory 1306.

Known forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can access data. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1302 for transmitting a computer data signal.

In some examples, execution of the sequences of instructions may be performed by computing platform 1300. According to some examples, computing platform 1300 can be coupled by communication link 1321 (e.g., a wired network, such as LAN, PSTN, or any wireless network, including WiFi of various standards and protocols, Bluetooth®, NFC, Zig-Bee, etc.) to any other processor to perform the sequence of instructions in coordination with (or asynchronous to) one another. Computing platform 1300 may transmit and receive messages, data, and instructions, including program code (e.g., application code) through communication link 1321 and communication interface 1313. Received program code may be executed by processor 1304 as it is received, and/or stored in memory 1306 or other non-volatile storage for later execution.

In the example shown, system memory 1306 can include various modules that include executable instructions to implement functionalities described herein. System memory 1306 may include an operating system (“O/S”) 1332, as well as an application 1336 and/or logic module(s) 1359. In the example shown in FIG. 13, system memory 1306 may include any number of modules 1359, any of which, or one or more portions of which, can be configured to facilitate any one or more components of a computing system (e.g., a client computing system, a server computing system, etc.) by implementing one or more functions described herein.

The structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques, including, but not limited to, FORTH, ASP, ASP.net, .Net framework, Ruby, Ruby on Rails, C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, PHP, and others. Design, publishing, and other types of applications such as Dreamweaver®, Shockwave®, Flash®, Drupal and Fireworks® may also be used to implement at least one of the described techniques or variations thereof. Database management systems (i.e., “DBMS”), search facilities and platforms, web crawlers (i.e., computer programs that automatically or semi-automatically visit, index, archive or copy content from, various websites (hereafter referred to as “crawlers”)), and other features may be implemented using various types of proprietary or open source technologies, including MySQL, Oracle (from Oracle of Redwood Shores, Calif.), Solr and Nutch from The Apache Software Foundation of Forest Hill, Md., among others and without limitation. The described techniques may be varied and are not limited to the examples or descriptions provided. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, modules 1359 of FIG. 13, or one or more of their components, or any process or device described herein, can be in communication (e.g., wired or wirelessly) with a mobile device, such as a mobile phone or computing device, or can be disposed therein.

The computing device may be disposed in autonomous vehicle 1390b as autonomy controller 1320a.

In some cases, a mobile device, or any networked computing device (not shown) in communication with one or more modules 1359 or one or more of its/their components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figures can represent one or more algorithms. Or, at least one of the elements can represent a portion of logic including a portion of hardware configured to provide constituent structures and/or functionalities.

For example, modules 1359 or one or more of its/their components, or any process or device described herein, can be implemented in one or more computing devices (i.e., any mobile computing device) that may include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit.

For example, modules 1359 or one or more of its/their components, or any process or device described herein, can be implemented in one or more computing devices that include one or more circuits. Thus, at least one of the elements in the above-described figures can represent one or more components of hardware. Or, at least one of the elements can represent a portion of logic including a portion of a circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

1. A method comprising:
localizing an autonomous vehicle relative to a first geographical location at which the autonomous vehicle is disposed relative to a first path portion of a path of travel;
capturing data representing vehicular drive parameters at units of time as the autonomous vehicle transits via the path of travel;
determining the autonomous vehicle is adjacent to a parking zone;
localizing the autonomous vehicle relative to a second geographical location at which the autonomous vehicle is disposed relative to a second path portion of the path of travel;
storing the data representing the vehicular drive parameters; and
computing a reverse path of travel in a reverse direction of travel over the path of travel based on the data representing the vehicular drive parameters.

2. The method of claim 1 wherein capturing the data representing the vehicular drive parameters comprises:
accepting control signals from a subset of user control devices; and
initiating data capture to form a programmed path of travel.

3. The method of claim 2 wherein the subset of the user control devices comprises one or more of a steering mechanism, a throttle, a braking device, and a transmission shifting control.

4. The method of claim 2 wherein initiating the data capture comprises:
receiving an initiation signal originating at a user interface.

5. The method of claim 1 wherein localizing the autonomous vehicle relative to the first path portion and the second path portion comprises:
localizing the autonomous vehicle at a boundary and a parking zone, respectively, during ingress of the parking zone,
wherein the reverse path of travel is computed to cause the autonomous vehicle to exit the parking zone automatically.

6. The method of claim 1 wherein localizing the autonomous vehicle relative to the first path portion and the second path portion comprises:
localizing the autonomous vehicle at a parking zone and a boundary respectively, during egress of the parking zone,
wherein the reverse path of travel is computed to cause the autonomous vehicle to enter the parking zone automatically.

7. The method of claim 1 wherein capturing the data representing the vehicular drive parameters comprises:
determining a vehicle drive parameter indicative of a transmission configured in a first drive state in association with the first path portion; and
determining the vehicle drive parameter indicative of the transmission configured in a second drive state in association with the second path portion.

8. The method of claim 1 wherein the second path portion is disposed at a location coinciding with a parking port including a number of objects as obstacles.

9. The method of claim 8 further comprising:
executing instructions of a programmed parking application to propel the autonomous vehicle via the reverse path of travel to terminate transit of the autonomous vehicle at a pre-determined pose.

10. The method of claim 9 wherein executing instructions of the programmed parking application comprises:
identifying an image target; and
determining a position and orientation relative to the image target.

11. The method of claim 9 wherein executing instructions of the programmed parking application comprises:
executing a first subset of instructions to position a side surface portion of the autonomous vehicle at a distance that optimizes spatial dimensions adjacent another side surface portion.

12. The method of claim 9 wherein executing instructions of the programmed parking application comprises:
executing a second subset of instructions to detect absence of a passenger at an exit associated with a side surface;
calibrating a distance between the side surface and an object in the parking port; and
controlling the autonomous vehicle to terminate transit at a modified pose at the distance.

13. The method of claim 9 wherein executing instructions of the programmed parking application comprises:
executing a third subset of instructions to detect absence of passengers;
calibrating the pose to form a modified pose in the parking port; and
controlling the autonomous vehicle to terminate transit at the modified pose.

14. The method of claim 1 further comprising:
detecting an impeding object on the second path portion disposed at a location coinciding with a parking port.

15. The method of claim 14 further comprising:
receiving data representing a modified path of travel at the second path portion to automatically terminate transit at an alternate pose in the parking port.

16. An apparatus comprising:
a memory including executable instructions; and
a processor, responsive to executing the instructions, is configured to:
localize an autonomous vehicle relative to a first geographical location at which the autonomous vehicle is disposed relative to a first path portion of a path of travel;
capture data representing vehicular drive parameters at units of time as the autonomous vehicle transits via the path of travel;
determine the autonomous vehicle is adjacent to a parking zone;
localize the autonomous vehicle relative to a second geographical location at which the autonomous vehicle is disposed relative to a second path portion of the path of travel;
store the data representing the vehicular drive parameters; and
compute a reverse path of travel in a reverse direction of travel over the path of travel based on the data representing the vehicular drive parameter.

17. The apparatus of claim 16, wherein the processor is further configured to:
accept control signals from one or more of a steering mechanism, a throttle, a braking device, and a transmission shifting control; and
initiate data capture to form a programmed path of travel.

18. The apparatus of claim 17, wherein the processor is further configured to:
localize the autonomous vehicle relative to the first path portion at a boundary; and
localize the autonomous vehicle relative to the second path portion at a parking zone,
wherein the reverse path of travel is computed to cause the autonomous vehicle to exit the parking zone automatically.

19. The apparatus of claim 16, wherein the processor is further configured to:
localize the autonomous vehicle relative to the first path portion at a parking zone; and
localize the autonomous vehicle relative to the second path portion at a boundary,
wherein the reverse path of travel is computed to cause the autonomous vehicle to enter the parking zone automatically.

20. The apparatus of claim 16, wherein the processor is further configured to:
activate driverless recharging in accordance with a schedule; and
execute instructions of a programmed parking application to propel the autonomous vehicle to terminate transit of the autonomous vehicle at a predetermined pose at a battery charging station.
